(19) United States
(12) Patent Application Publication
(10) Pub. No.: US 2016/0035392 A1
(43) Pub. Date: Feb. 4, 2016

(54) SYSTEMS AND METHODS FOR CLIPPING VIDEO SEGMENTS

(71) Applicant: Didja, Inc., San Francisco, CA (US)

(72) Inventors: Aaron D Taylor, Haddonfield, NJ (US); Sufan Chou, Union City, CA (US); Delmer R Schneider, Jr., Manteca, CA (US); Michael J Sobieski, Petaluma, CA (US); Andrii Skaliuk, San Bruno, CA (US); Jay Perry, Los Altos, CA (US); Ashwin S Kashyap, Mountain View, CA (US)

(21) Appl. No.: 14/682,093

(22) Filed: Apr. 8, 2015

Related U.S. Application Data
(63) Continuation-in-part of application No. 13/684,162, filed on Nov. 22, 2012.
(60) Provisional application No. 61/976,686, filed on Apr. 8, 2014.
(60) Provisional application No. 62/072,290, filed on Oct. 29, 2014.

(51) Int. Cl. G11B 27/34; G11B 27/031; G06K 9/00

(52) U.S. Cl. CPC G11B 27/34; G06K 9/00711; G11B 27/031

(57) ABSTRACT

Systems and methods for streaming video, interacting with video content, and sharing video content are disclosed herein. Other embodiments are also disclosed herein.

### CROSS-REFERENCE TO RELATED APPLICATIONS

This application is a continuation-in-part of U.S. patent application Ser. No. 13/684,162, filed on Nov. 22, 2012, and claims priority to U.S. Provisional Patent Application No. 61/976,686, filed on Apr. 8, 2014, and U.S. Provisional Patent Application No. 62/072,290, filed on Oct. 29, 2014, all of which are incorporated h reference in their entireties.

### FIELD OF THE INVENTION

The present application relates to systems and methods for user interaction on a mobile device. One embodiment is an application enabling a user to preview a short video “Scene” and capture as small segment, or “Clip” from that Scene.

### BRIEF DESCRIPTION OF THE DRAWINGS

To facilitate further description of the embodiments, the following drawings are provided. The same reference numerals in different figures denote the same elements.

FIG. 1 illustrates a block diagram of an example of as system for streaming content, according to an embodiment.

FIG. 2 illustrates a block diagram of an example of a system for streaming content, according to an embodiment.

FIG. 3 illustrates a flow chart of an example of a method of detecting video content, according to an embodiment.

FIG. 4 illustrates examples of audio and video signals and examples of the types of information that those respective signals can contain.

FIG. 5 illustrates a flow chart of an example of a method of interacting with content clips, according to an embodiment.

FIG. 6 illustrates a flow Chart of an example of as method of collecting event and/or interaction data, according to an embodiment.

FIG. 7 illustrates a flow chart of an example of a method of recommending content, according to an embodiment.

FIG. 8 illustrates a flow chart of an example of a method of creating clips, according to an embodiment.

FIG. 9 illustrates a block diagram of a system for creating an automated playlist, according to an embodiment.

FIG. 10 illustrates an example of screen shot of a mobile device displaying one or methods according to an embodiment.

FIG. 11 illustrates an example of screen shot of a mobile device displaying one or methods according to an embodiment.

FIG. 12 illustrates an example of screen shot of a mobile device displaying one or methods according to an embodiment.

FIG. 13 illustrates an example of screen shot of a mobile device displaying one or methods according to an embodiment.

FIG. 14 illustrates an example of screen shot of a mobile device displaying one or methods according to an embodiment.

FIG. 15 illustrates an example of a block diagram displaying a method for granting a user access to content according to an embodiment.

FIG. 16 illustrates an example of a block diagram displaying a method for updating user tokens according to an embodiment,

FIG. 17 illustrates an example of a block diagram displaying a method for monitoring user location within a venue according to an embodiment.

FIG. 18 illustrates an example of a diagram of an example of a method for distributing and editing video Scene and Clip content, according to an embodiment.

FIG. 19a illustrates an example of a screenshot showing a list of scenes from a single program on a mobile device, according to an embodiment.

FIG 19b illustrates an example showing a quarter overlap between thumbnail images according to an embodiment

FIG. 20 illustrates an example of a screenshot of a method of selecting and/or editing video, according to an embodiment.

FIG. 21 illustrates an example of a flowchart for a method of creating a desired Clip, according to an embodiment.

FIG. 22 illustrates a screenshot of a user selecting a “cover” image to use when posting a newly created Clip into the App, according to an embodiment.

FIGS. 23-27 illustrate examples of various tables that show different types of data, according to an embodiment.

### DETAILED DESCRIPTION

In some embodiments of the present invention, systems and methods of interacting with an event are disclosed. In the same or other embodiments, the systems and methods include providing a way for users to interact with others as it relates to an event. In the same or other embodiments, the systems and methods allow users to receive video clips of an event. The clips can then be used to interact with other individuals.

According to embodiments of the present invention, a user can use a device, such as, for example, a mobile phone, a tablet device, a computer, or a custom designed device, to indicate that he is watching a particular event. The event can comprise, for example, a television program, a movie, streaming video content, a live event (e.g., a sporting event, a concert, a play, etc.). The device can then be used to determine what event the user is watching. For example, the audio of a television program can be used to determine what program is being watched, and even what channel is being watched. In other examples, GPS can be used to determine that the user is at a particular sporting venue in which a sporting event is taking place. In the same or other examples, user interaction via text or voice input can be used to determine what event the user is watching.

According to embodiments of the present invention, once the device has been used to determine what event the user is watching (with possible help from a backend server), data concerning the event can be presented to the user via the device. For example, for a television program, the title, channel, actors, and other information can be given to the user. In addition, video clips of the television program can be presented to the user. Multiple clips can be presented each a certain length in time, thereby allowing the user to choose a particular clip of interest.

In some embodiments, users can access content that can be restricted by the content owners. The owners of the content can restrict interaction with their content. As an example, business rules can be created to restrict access to the content. These business rules may be based, for example, on user location, presence of content feeds, user subscriptions to content provider services, and other factors not specifically mentioned in this disclosure.

In some embodiments, user interactions with content may include, for example: previewing content via image thumbnails, replaying the last few minutes of a video, clipping video content, saving video content, and sharing image thumbnails. In the same or other embodiments, content may have usage restrictions. For example, some content may be able to be shared with other users, while other content may be only previewed. In the same or other embodiments, some content may have different restrictions based on the user. For example, one user may be able to share the content with other users, while another user may only be able to preview the content.

In some embodiments of the present invention, tokens may be used to allow users to interact with copyrighted content based on the user's authentication level. The tokens may grant permanent or temporary access to content. As examples, tokens may be granted on: user location, user subscriptions to services, actions performed by the user, user status, possession of tokens, and other factors as appropriate. In some embodiments, tokens may be data values or digital certificates stored in the system. In some embodiments, a list or table of tokens belonging to a specific user may be stored along with other user data. Users may possess multiple tokens at a time.

As an example, in some embodiments, users can be granted access to content via the following steps: the user requests access to content; the system determines if the content is valid; if the content cannot be found or access to the content has been denied the content will be deemed invalid; if the system determines that the content is valid, the system will retrieve a list of acceptable user tokens and content tokens; if at least one of the user tokens is deemed sufficient, the system will grant access to the content. In some embodiments, the granted access may allow for temporary or permanent use of the accessed content depending upon the tokens held by the user accessing the content.

Further, in some embodiments, user tokens can be updated when a user successfully matches a program. For example, a user starts audio detection and the system captures audio, extracts, and looks up the fingerprints at the server backend. If as match of the fingerprint is found, the user will be granted an audio match token for the corresponding content that was matched.

In some embodiments of the present invention, user tokens can be updated when a user changes location. When the user changes location, the system determines the location of the user and sends the user's location data to the backend server. This can cause all, or a portion thereof, of the Global Positioning System (GPS) tokens currently held by the user to expire. If there is a content match in the rules table on the backend server, the user can be granted at token for the matched content. If no content match is found in the rules table on the backend server, the system can retry the process when the user changes location. In some embodiments, user location can tracked within certain venues such as, for example, event centers, stadiums, and other public gatherings.

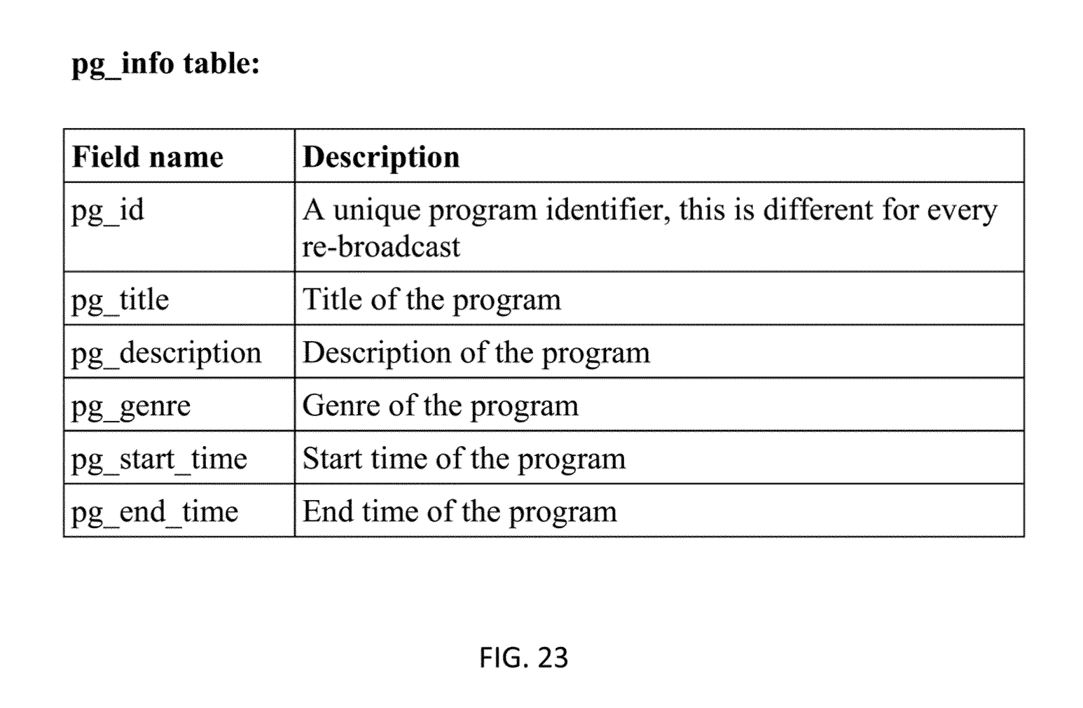

In some embodiments, users can possess multiple tokens and/or multiple types of tokens. Multiple types of tokens may be available. In addition to the examples of FIGS. 23-27, the following are further examples:

Users may obtain tokens after a user successfully completes an action. User authenticated tokens require a user to possess an authentication status. Users of TV-everywhere authenticated tokens require a user to possess a TV-everywhere authentication status. Coupon tokens require users to possess a coupon. Audio-fingerprinting (AFP) matched tokens require the user to have successfully matched the program. In some embodiments it may be necessary to match a program within a given time window. Paid subscription tokens require a user to possess a paid subscription. Global Positioning System (GPS) tokens require a user to be within a certain region. It should be noted that other types of tokens nor specifically mentioned herein may be available.

In some embodiments, various tokens can allow different types of access to content. Different access types provided by various tokens may include the following: “Preview” access can allow a user to preview the content using thumbnails. “Replay” access can allow a user to replay video of the content in the recent past, “Save clip” access can allow a user to clip content and save for personal use. “Share clip” access can allow a user to clip content and share the clipped content with others. “Share image” access can allow a user to share thumbnails of content. “Save program” access can allow users to save an entire program on a digital video recorder system (DVR). In addition, tokens may allow other types of access to content not specifically mentioned herein.

In addition, in some embodiments, if the user's location is within a specified boundary of a live event, such as, for example, a sporting event, and that event is being broadcast, the user is granted privileges to interact with said content of the broadcast of the event.

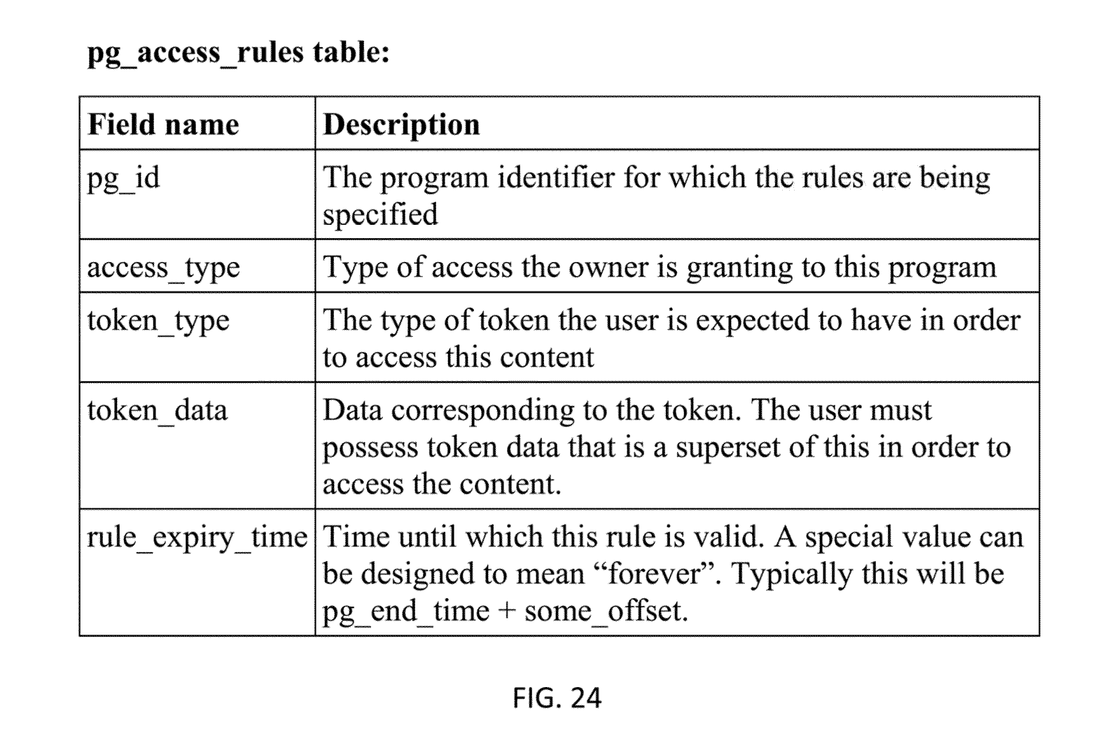

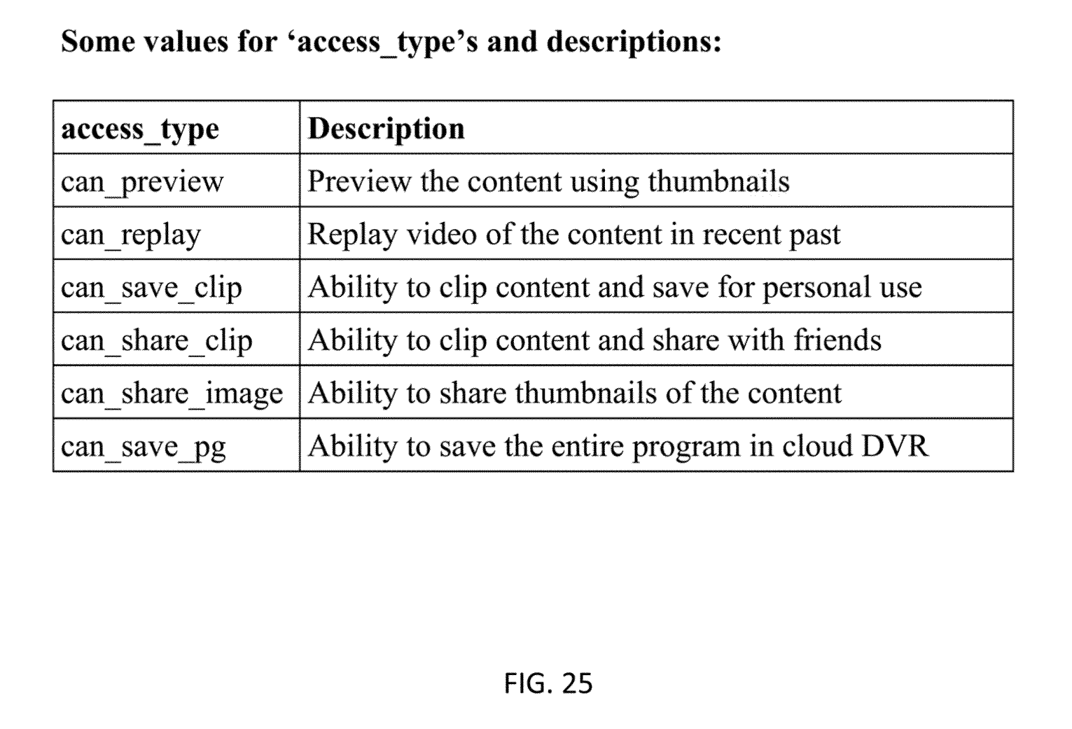

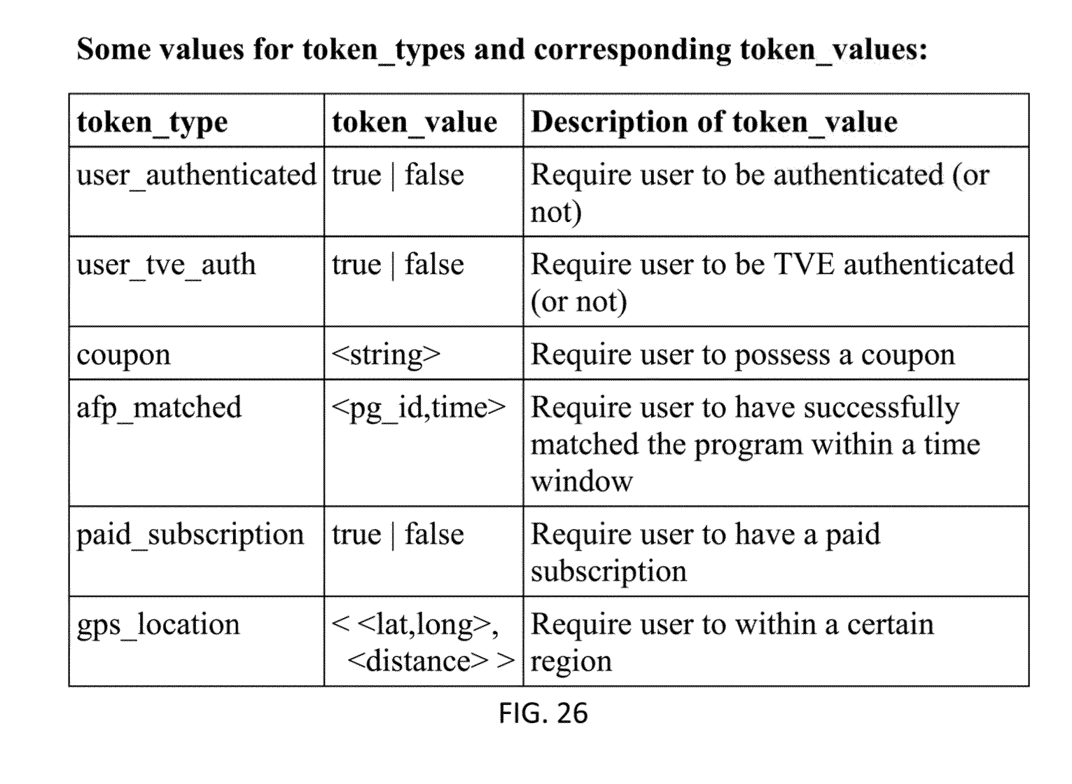

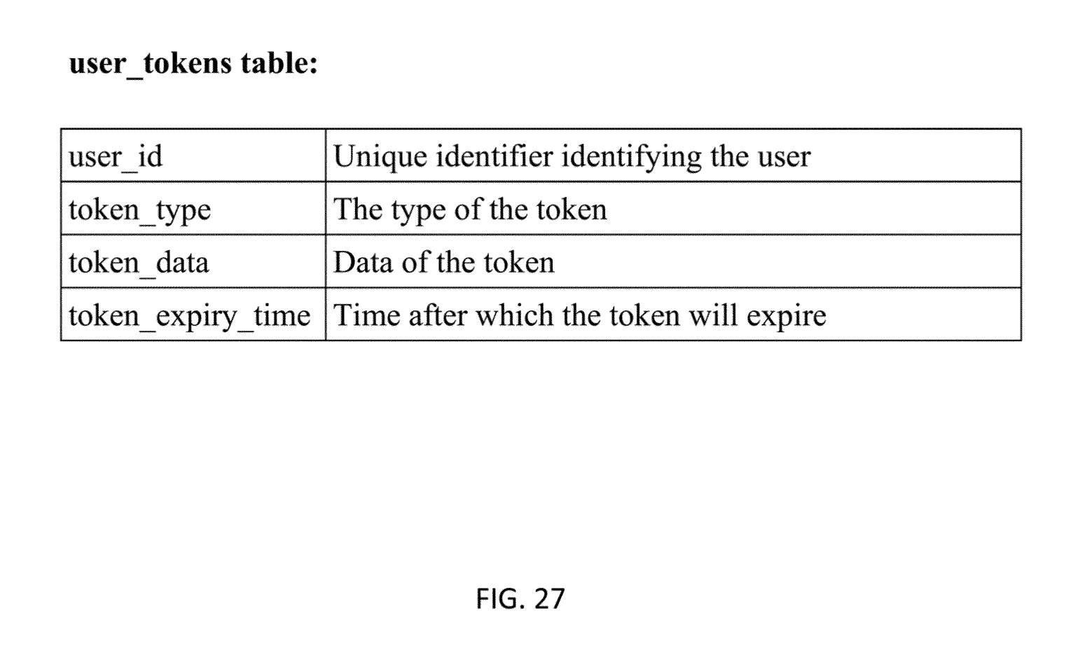

FIG. 23-27 illustrate examples of various tables that show different types of data. For example, FIG. 23 illustrates information related to identification and data related to a TV program. FIG. 24 illustrates, for example, the type of access give to various users of a program. FIG. 25, for example, illustrates examples of access type for scenes. FIG. 26 shows an example of a table comprising different types of tokens and their corresponding values. Finally, FIG. 27 shows an example table of a mapping of a user to his or her tokens.

In the same or other examples, the data about the event can include information about the scene of television program. For example, the data can include the designer of the dress that a character in a television program is wearing, where a person can buy that dress, the cost of the dress, coupons for the dress, and the like. It should be noted that any possible information about an event can be provided to the user.

According to embodiments of the present invention, the user can select the data presented, such as, for example, one of the video clips, and interact with others. For example, the user can send the video clip to other individuals via MMS text, social network (e.g., Facebook, Twitter, etc.), and the like. In addition, the user can also include comments with the deliverable data.

In the same or other embodiments of the present invention, the systems and methods can include providing a suggestion to a user of what would be interesting to watch, or what programs are being watched. In some embodiments, the systems and methods disclosed herein use what is trending (for example, what is trending on twitter or other social networks) to determine what is being watched. In the same or other embodiments, the systems and methods disclosed herein use what a users contacts are watching to determine what is being watched. It should be noted that other methods for determining what is being watched not specifically described herein can be used.

According to embodiments of the present invention, the user may record comments in sync with the original video clip. In some embodiments, the user presses a “record” button while previewing the selected video clip. When the button is pressed, audio is recorded and sent to the web server for sharing. In the same or other embodiments, the original audio is mixed with the commentary audio on the server side of the system, unless the content delivery network (CDN) is incapable of supporting the server side mixing of audio, in which case, the system will resort to client side audio mixing.

Some embodiments of the present invention allow a user to do “audio search”, wherein the user captures a snippet of audio of a TV program. In the same or other embodiments, an audio fingerprinting and indexing system can match the audio query to a corresponding program, such as, for example, a television program. The audio search technology can be deployed on consumer devices such as, for example, tablets, mobile phones, set-top-boxes, or computers.

In one example, the current system captures up to twenty seconds of audio samples when determining the correct program. In other examples the system can use audio samples of greater than twenty second or less than twenty seconds when determining the correct program.

The function of the audio fingerprint module is to process chunks of audio (in one embodiment, seven seconds of audio, although it should be noted that this can be greater than seven seconds or less than seven seconds in other embodiments). The audio is then processed to generate a compact fingerprint that can uniquely represent the audio. In some examples, the audio is processed using fast fourier transform and other audio processing algorithms. In some embodiments, the fingerprint is a list of integers. In the same or other embodiments, the number of such integers generated ranges of approximately 30-50 per second of audio. In some embodiments, the number of such integers ranged less than approximately 30 per second of audio. In other embodiments, the number of such integers ranged greater than approximately 50 per second of audio. In some embodiments of the present invention, a total of approximately 20 seconds of audio is captured to determine the matching program. It should be noted that more than or less than 20 seconds of audio can be used.

In some embodiments, the core fingerprint extraction algorithms run both on the frontend as well as the backend.

The front end component is typically run on consumer devices such as, for example, mobile phones, tablets, internet-enabled set-top-boxes, or computers. These components comprise an audio fingerprint extraction module. The audio fingerprint module needs audio data (for example, up to 20 seconds of audio) to be captured, before it can be processed and the corresponding program can be matched.

Once these fingerprints are generated, the device sends a suitably encoded version of the list of integers to the backend server. The server is able to efficiently determine the TV show that is the closest match to the given query and responds with this information which is encoded suitably. In some embodiments the JavaScript Object Notation (JSON) format is used to encode the information for transfer between the client device and the database. In the same or other embodiments, the encoded information is communicated to the backend server by means of a Remote Procedure Call (RPC) mechanism. In the same or other embodiments, the RPC mechanism comprises as JSON-encoded message delivered via the HTTP protocol. In the same or other embodiments, the backend system decodes the JSON-encoded message, retrieves the corresponding clips, and sends a JSON-encoded response message back to the client device.

As outlined above, the fingerprinting module processes, for example, 7 second chunks of audio and returns a list of integers that uniquely represent the audio. The indexer builds an inverted index out of these lists of integers. In other words, for each fingerprint integer, a list of audio files that contain this fingerprint is associated. When a query is presented to the server, it looks up all the audio files that contain this list of fingerprints and calculates a frequency score for every audio file containing the matching integers. It should be noted that the fingerprinting module processes can comprise further procedures not specifically mentioned herein.

In some embodiments of the present invention, a process background matching is employed. The steps involved are as follows:
1. The app captures microphone input periodically and does a fingerprint match as explained earlier. This is done every 30-60 seconds and is not user initiated and not necessarily user visible. It should be noted that less than 30 seconds or more than 60 seconds can be used.
2. The outcome of this lookup could be one of:
   a. Single Real match with a certain confidence score
   b. Multiple matches with multiple confidence scores.
   c. False positive matches with a confidence scores
   d. No match (and no score)
3. A history of the results is maintained. When a user clicks on a particular result, the system remembers this. For example, if the server returns [“ABC”, “KPIX”, “ESPN”] as possible matches but the user selects “ESPN” even though the confidence score was lower, we give preference to the user's selection by means of linearly combining the result score with the user's preference as follows: (0.5*score+0.5*1.0). Where the 1.0 score signifies the user selected a particular result hence a bias towards that particular result.
4. On subsequent lookups, if the same program/channel is returned, the history result is updated by linearly combining the old score and the new. The importance of the old score is diminished so that when the user switches the channel/program the event is able to be determined. At the same time, it is preferable to avoid detecting a false positive match as a legitimate match. In general, the score is updated as follows: (alpha*old_score+(1−alpha)*new_score). These parameters need to be selected intelligently and tuned appropriately. Notice that if a false positive match is not subsequently returned, the new_score is zero and the final score gradually reaches 0.
5. When the user taps on “Automatically detect”, a list of matches is selected that have the highest score and display the results sorted by respective scores.

In some embodiments the Closed Captioning data is extracted by means of an EIA-608 decoder (commonly known as line 21). In the same or other embodiments, after the raw text is extracted, the text is further processed in order to identify named-entities, such as, for example, brands, celebrities, places, etc. In some embodiments errors in the Closed Captioning are corrected by natural language processing techniques.

In some embodiments, a database of objects with corresponding metadata is available. The objects in the database represent ads to be shown, coupons, ads for related shows, or poll questions, for example. Each object's metadata describes properties of the object, such as the category of the ads.

The process of creating this metadata could be manual or automated, and in some embodiments, each of the metadata items is assigned a unique integer. In addition, this database could be populated manually based on sales or in more automatic manner such as by using coupon search engines or ad exchanges.

The metadata of each of the object can be represented in the standard vector space model as follows:

dj=(w1,j,w2,j, . . . , wt,j)

Where,

d is the object/document in question;

j is the jth object in the database;

w represents the category or term. It is assumed, each category has a unique I.D.;

t is the total number of categories.

In order to show relevant ads to the user, it may be desirable to understand the topics and categories that a particular user is interested in. This process is generally referred to as behavioral profiling and can be accomplished using a plethora of means including the use of tracking cookies. In one embodiment, this profile can be represented in the standard vector space as follows:

q=(w1,q,w2,q, . . . , wt,q)

Where.

q represents the user's profile;

w represents the category as already explained above.

It should be noted that the user's profile evolves and changes over time based on how the user consumes and interacts information. In general, it may be necessary to “age” previous topics and categories and give importance to more recent interests of the user.

One embodiment of the present invention determines if an object in the database is relevant to what the current user by the standard cosine similarity of the two vectors defined as:

$$cos θ = \frac{{d}_{2} \cdot q}{‖ {d}_{2} ‖ ‖ q ‖}$$

Where,

d2•q is the dot product (or inner product) of the document or object vector and the user profile vector.

Notice that the running time is linear in the number of objects in the database, however this process can be speeded up by maintaining an inverted index. Furthermore, in some embodiments, it is assumed that the database of objects is not on the mobile device but is deployed alongside the backend system or in a suitable manner. Also, in the same or other embodiments, the entire matching process can be significantly different and more complicated than doing a simple cosine similarity.

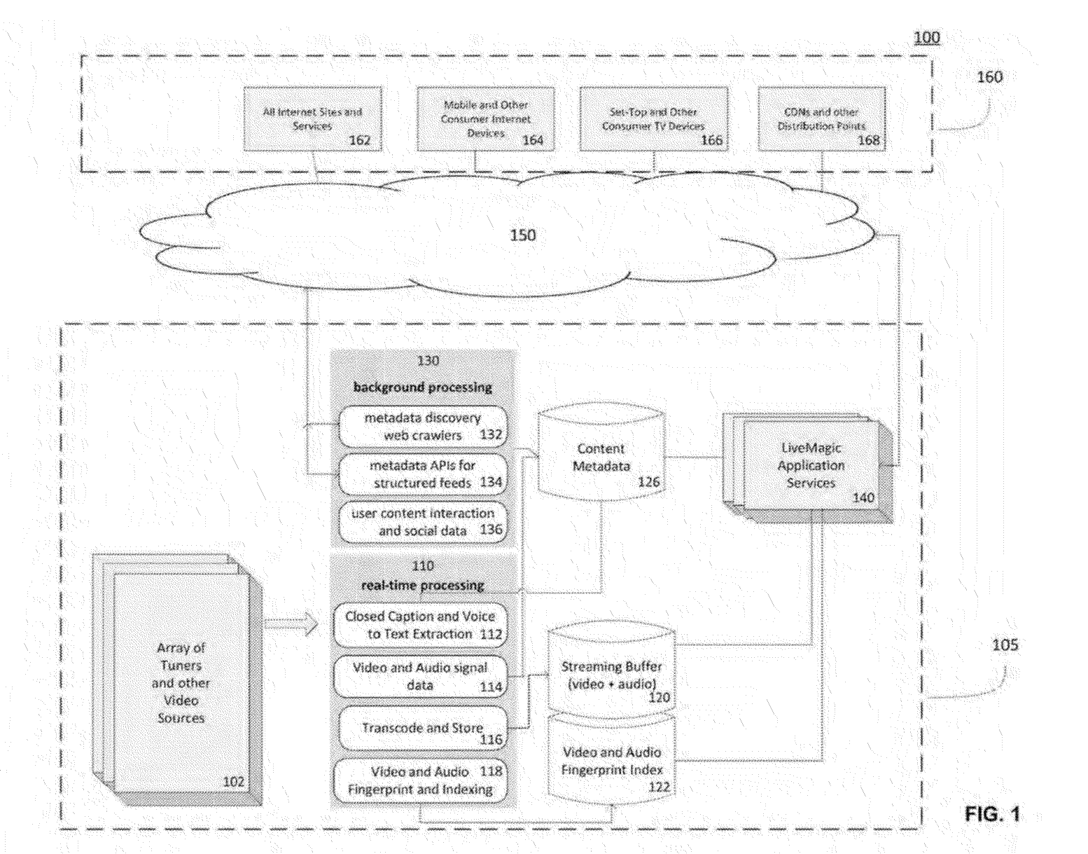

Turning to the drawings, FIG. 1 illustrates an example of a system 100 for streaming content, according to an embodiment. In the same or different embodiments, system 100 can be a digital video recorder (DVR) system for streaming content and user interaction. System 100 is merely exemplary and is not limited to the embodiments presented herein. System 100 can be employed in many different embodiments or examples not specifically depicted or described herein.

According to some embodiments, the system can comprise a backend and a frontend. The backend can be used for content acquisition in these embodiments. Examples of backend components are shown in the box defined as 105 in FIG. 1. The frontend can comprise apps that run on consumer devices such as, for example, mobile phones, tablets, internet-enabled set-top-boxes, computers, smart televisions, and the like. Examples of frontend components are shown in the box defined as 160 in FIG. 1.

In the embodiment of FIG. 1, system 100 comprises one or more video components 102. Video components 102 can include an array of tuners capable of receiving and delivering video signals. The video turners can include, for example, boxes capable of receiving a cable television input, boxes capable of receiving a satellite television input, boxes capable of receiving a fiber optic input, antennas signals capable of receiving over-the-air television broadcasts, or combinations thereof. In some embodiments, one or more video components may be able to transmit all television programming from broadcast, cable, and/or satellite providers to a processing unit. In addition, video components can comprise devices that produce video signals from DVDs, BDs, CDs, internet sources, and the like. It should be noted that video components 102 can comprise any devise capable of producing a video signal. Also, in addition to the video signals that are produced from video components 102, there can also be audio signals coupled to the video signals.

System 100 can also comprise a processing unit 110. In some embodiments, processing unit 110 can be considered a real-time processing unit. Processing unit 110 is where the processing of the video (and audio) signals received from the one or more video components 102 occurs. Processing unit can comprise a closed caption unit 112; a signal data unit 114; a transcoding unit 116; and a fingerprinting unit 118.

The closed caption unit 112 can take the closed caption data from the video/audio feeds as received from the video components 102. The data can be mined for information relating to the video signal that is incoming. For example, if the video signal coming from video components 102 is representative of a football game, the closed caption may comprise the word “touchdown.” This is indicative of something that has occurred in the football game and can be stored as metadata. In addition the closed caption unit 112 can also perform voice to text extraction. As an example, the audio signal can be translated to text. For example, the announcer may say “touchdown” in the football example. Once again, this is important information that can be saved as metadata.

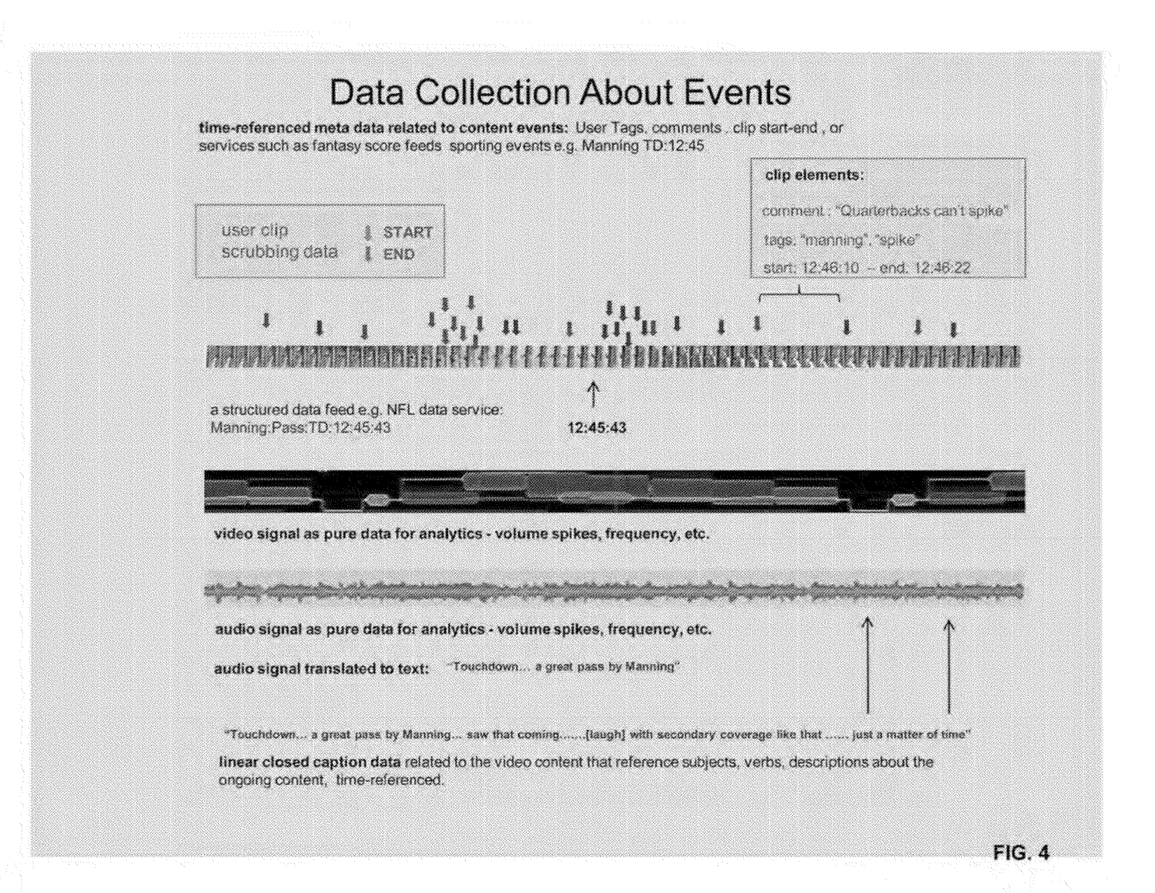

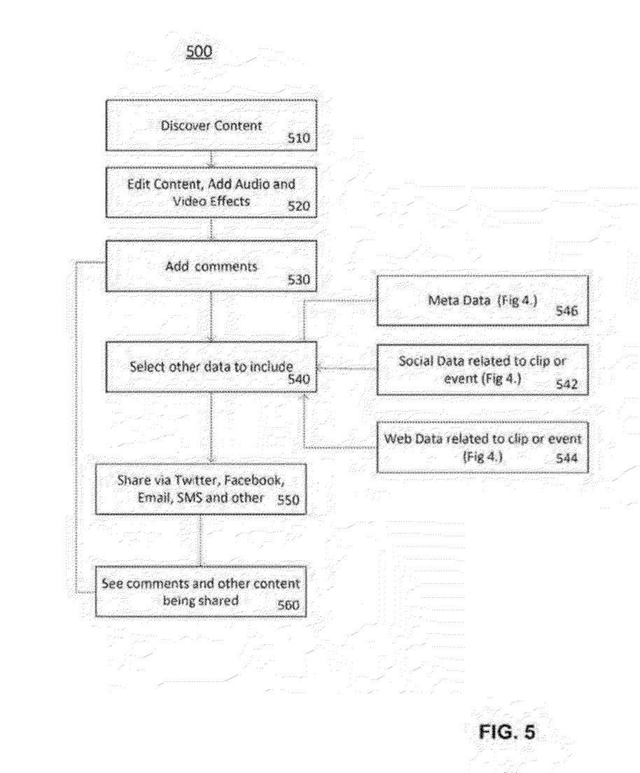

The signal data unit 114 can take the audio and video data signals and mine those signals for pertinent information, which can be stored as metadata. FIG. 4 shows examples of audio and video signals and the types of information that those respective signals can contain. As examples, volume spikes, frequency, etc. can be used to determine whether an important moment in the television program has taken place.

The transcoding unit 116 can take the signals (video and audio) received from the video components 102 and transcode and store the signals. Transcoding allows the signals to be converted to a uniform file format and allows for a compression of the files. The transcoding unit can use any number of transcoding methods now known or hereinafter developed.

The fingerprinting unit 118 can comprise audio fingerprinting and video fingerprinting capabilities. The audio fingerprinting takes the audio signal as received from the video components 102 and processes the audio signal to generate a compact fingerprint that can uniquely represent the audio. In some examples the audio fingerprint module processes chunks of audio (for example, a chunk of seven seconds of audio can be used, although it should be noted that this more than seven seconds or less than seven seconds of audio signal can be used). In some examples, the audio is processed using fast fourier transform and other audio processing algorithms. In some embodiments, the fingerprint is a list of integers. In the same or other embodiments, the number of such integers generated ranges of approximately 30-50 per second of audio. In some embodiments, the number of such integers ranged less than approximately 30 per second of audio. In other embodiments, the number of such integers ranged greater than approximately 50 per second of audio. In some embodiments of the present invention, a total of approximately 20 seconds of audio is captured to determine the matching program. It should be noted that more than or less than 20 seconds of audio can be used.

The video fingerprinting takes the video signal as received from the video components 102 and processes the video signal to generate a compact fingerprint that can uniquely represent the video received. In some examples, the video is processed scene by scene, thus allowing a still picture of a video to matched using the fingerprinting analysis. In other examples, the video is processed using a particular amount of time of the video signal. Any amount of time can be used to process the video.

System 100 can also include a number of databases. These databases can be used to store data obtained from the video components 102 after the data has been processed by the processing unit 110. In the same or other embodiments, data obtained from the video components 102 may be stored in a database without being processed by the processing unit 110. Embodiments of the present invention can comprise to fingerprint database 122, a streaming buffer database 120, and a content metadata database 126. In some embodiments fingerprint database 122, streaming buffer database 120, and metadata database 126 may be a single database. In other embodiments, one or more of fingerprint database 122, streaming buffer database 120 or metadata database 126 can comprise a plurality of databases. In addition system 100 can also include other databases not specifically mentioned herein.

In the example illustrated in FIG. 1, data that has been processed by the fingerprinting unit 118 is stored within the fingerprint database 122. This data can include, for example, the fingerprints of the video data and/or the audio data that has been received from the video components 102.

According to the example of FIG. 1, data that has been processed by the transcoding unit 116 is stored within the streaming buffer database 120. This data can include, for example, the transcoded video and/or audio data that has been received from the video components 102.

Also, as shown in the example of FIG. 1, data that has been processed by the closed caption unit 112 and the signal data unit 114 is stored within the content metadata database 126. This data can include, for example, data that is gleaned from the incoming data video and/or audio signals (such as, for example volume spikes and/or frequency). In addition the data can also include data that has been extract from the closed caption data of the video signals and/or data that has been extracted by converting the voice data found in the audio signals to text.

With continued reference to FIG. 1, system 100 can include a network 150. As an example, network 150 can comprise the Internet and/or a cellular telephone/data network. In other examples, network 150 can comprise a network specifically created for the systems and methods discussed herein.

System 100 can also comprise a background processing unit 130. Background processing unit 130 can be connected with the network 150. Background processing unit 130 is where the processing of the how people interact with the video (and audio) signals received from the one or more video components 102. The background processing unit 130 is capable of processing pertinent information relating to particular video clips. For example, the background processing unit 130 can determine how people view clips of video, such as how often a particular video clip is played, how often a particular video clip is shared, or how often a particular video clip is skipped. Background processing unit can comprise a metadata discovery web crawlers unit 132; an API unit 134; and a user content interaction unit 136.

The metadata discovery web crawlers unit 132 can search the network 150, which can be the Internet for any type of information relating to a particular video clip. The data that is discovered can then be stored as metadata. For example, a video clip may be tagged with the word “touchdown,” or there may be one or more comments regarding a football game, which has one or more video clips pertaining to it, on a website. In some embodiments, the metadata is stored in the content metadata database 126.

The API unit 134 can receive structured feeds from the network 150. These feeds can include, for example, feeds from real-time scoring services that provide real-time scoring updates, statistics, and other pertinent information from sporting events. Other types of structured feeds can also be processed via the API unit 134. In some embodiments, the data processed via the API unit 134 is stored in the content metadata database 126.

The user content interaction unit 136 can receive information on how users interact with clips and how the clips are shared on social networks. For example, the user content interaction unit 136 can determined how many times a clip has been share, viewed, skipped, etc. Furthermore, it can track what is trending, etc. In some embodiments, the data processed via the user content interaction unit 136 is stored in the content metadata database 126.

With continued reference to FIG. 1, system 100 can also comprise an application services unit 140. The application services unit can be configured to be connected to content metadata database 126, streaming buffer database 120, and fingerprint database 122. In addition, the application services unit can be connected to the network 150.

The application unit 140 is capable of running the applications of the system. Examples of the types of services and applications that can be performed by the application unit 140 can include, searching for video content, clipping and sharing videos, building a playlist of video clips, learning more about video content, automatically generating video clips, creating a fantasy sports playlist, etc. It should be noted that any number of applications can be run by the application service unit 140.

System 100 also includes frontend components 160. Frontend components 160 can include, for example, Internet sites and services 162, consumer devices 164, set-top devices 166, and CDNs 168. Each of the frontend components 160 is connected to the backend components 105 via the network 150. It should be noted that the frontend components can include other devices not specifically mentioned herein.

Internet sites and services 162 can include, for example, all other Internet sites. As an example, the system is connected to the Internet and can interact with any website or service that is similarly connected to the Internet.

Consumer devices 164 can include, for example, any mobile device or computer that consumers use to connect to the Internet. A mobile device can be any type of device that can receive data wirelessly from an external source. For example, a mobile device can be an Apple iPhone® device, a Blackberry® device, a telephone with an Android™ operating system, a mobile telephone, a PDA (personal digital assistant), an MP3 player, a portable computer, a tablet device, and/or other similar devices. A computer can be any computer that has access to the Internet or similar network connection. A computer can be a laptop and/or a desktop computer. It should be noted that the devices listed as examples for mobile devices and/or computers can include other devices than those specifically mentioned.

Set-top devices 166 can include, for example, smart televisions, Google® TV, and other similar boxes which can connect a television to the Internet. It should be noted that the devices listed as examples for set-top devices can include other devices than those specifically mentioned.

CDNs 168 can include, for example, content delivery networks (CDNs) and broadcasters. Examples of types of providers that can be considered CDNs 168 can include, hotels, cable providers, such as for example, Comcast®, satellite providers, and the like. In some examples, CDNs 168 will allow a user to create a personalized television channel, allowing the user to view a series of video clips created by the user. In some embodiments, such a personalized channel is created with application services unit 140.

The various components of system 100 can be configured a number of different ways. For example, the units (background processing unit 130, the processing unit 110, and the application services unit 140) can comprise one or more computers, servers, processing units, and the like.

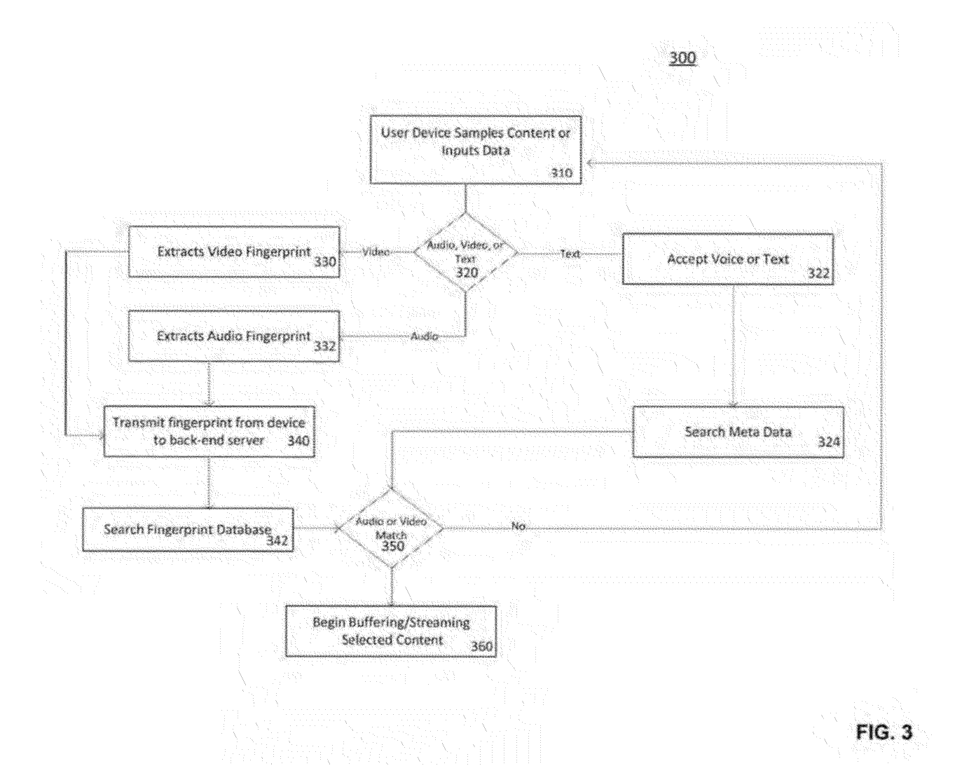

FIG. 3 is as flow chart illustrating an example of a method 300 of detecting video content. Method 300 can also be considered a method for detecting as particular video stream via video, audio, or voice/text information. Method 300 is merely illustrative of a technique for implementing, the various aspects of certain embodiments described herein, and method 300 is not limited to the particular embodiments described herein, as numerous other embodiments are possible. In some embodiments, the various procedures of method 200 can be performed by single computer or a set of computers.

Method 300 can include a procedure 310 of receiving an input from a user. The input can be in many different formats and can come from different types of devices, such as for example, mobile devices and/or computers. For example, the input can include audio, video, text, or voice. The video input, for example, can be a screen shot of a television program taken with the camera of a mobile device. In other examples, video input can be a recorded video for a particular period of time. The audio input, for example, can be an audio stream received from a mobile device. The text input can include a user entering text into a query on an application on a computer or mobile device. The voice input can include a user speaking into a mobile device to enter a query.

Next method 300 includes a procedure 320 of deciphering what type of input the user entered. In one example, during procedure 320 it is determined whether the user inputted video, audio, or voice/text data.

If the inputted data is video data, procedure 320 is followed by procedure 330. Procedure 330 is extracting the video fingerprint of the video data. If the inputted data is audio data, procedure 320 is followed by procedure 332. Procedure 332 is extracting the audio fingerprint from the audio data. In some embodiments, procedures 330 and 332 are performed on frontend components 160 of system 100. For example, procedures 330 and 332 can be performed by as mobile device.

Once the fingerprint (audio or video) has been extracted, the fingerprint is transmitted to the backend components 105 during procedure 340. In some examples, the fingerprint is transmitted to the backend components 105 via network 150 from a mobile device.

Next, method 300 can continue with as procedure 342 of searching a fingerprint database. The fingerprint database can be the same as or similar to fingerprint database 122. The fingerprint database is being searched for as fingerprint that matches the fingerprint that was sent via the device during procedure 340.

After procedure 342, method 300 continues with a procedure 350 of determining if there was a corresponding match for the inputted data. For example, if the inputted data was an audio stream, procedure 350 determines whether there is a fingerprint that matches the fingerprint extracted during procedure 332 and transmitted during procedure 340. Likewise, if the inputted data was video data, procedure 350 determines whether there is a fingerprint that matches the fingerprint extracted during procedure 330 and transmitted during procedure 340.

If there is a match, method 300 continues with a procedure 360 of streaming the selected content to the user. The content can be streamed, for example, to the user's mobile device or computer. In addition, procedure 360 can include buffering. In some embodiments, the streaming is conducted via network 150.

If there is not match, method 300 can continue with procedure 310. For example, the device may ask the user to enter another input (video, audio, or voice/text) to commence another search.

If the inputted data is text or voice data, procedure 320 is followed by a procedure 322. Procedure 322 is accepting the voice or text data from the user's device. In some examples, the voice or text data is transmitted to the backend components 105 from the frontend components 160 via network 150 during procedure 322. In yet other examples, if the data is voice data, the voice data is transformed to text data during procedure 322.

Procedure 322 is followed by a procedure 324 of searching the metadata to find a matching video. The metadata can be stored in the content metadata database 126.

After procedure 324, method 300 continues with a procedure 350 of determining if there was a corresponding match for the inputted data. For example, after the metadata was searched, there will be a determination if there are one or more video clips that match user's input.

If there is a match, method 300 continues with a procedure 360 of streaming the selected content to the user. The content can be streamed, for example, to the user's mobile device or computer. In addition, procedure 360 can include buffering. In some embodiments, the streaming is conducted via network 150.

If there is not match, method 300 can continue with procedure 310. For example, the device may ask the user to enter another input (video, audio, or voice/text) to commence another search.

It should be noted that method 300 and its procedures are merely exemplary. Many of the procedures can be rearranged without limiting the scope of the invention. In addition, other procedures not mentioned herein can be included within method 300 and/or procedures mentioned with respect to method 300 do not need to be included.

FIG. 5 is a now chart illustrating an example of a method 500 of interacting with content clips. Method 500 can also be considered a method for social interaction with video clips. Method 500 is merely illustrative of a technique for implementing the various aspects of certain embodiments described herein, and method 500 is not limited to the particular embodiments described herein, as numerous other embodiments are possible. In some embodiments, the various procedures of method 500 can be performed by single computer or a set of computers.

Method 500 can include a procedure 510 of discovering content. Procedure 510 can comprise a user receiving a streaming video or a particular video clip on a device. The device can be a mobile device or a computer. Other devices can be included also. The video (or audio, or a combination thereof) is delivered to the user device from backend components via a network. The network can be the same as or similar to network 150 and the backend components can be the same as or similar to backend components 105. Procedure 510 can be the same as or similar to method 300 of FIG. 3. In other examples, procedure 510 is not the same as method 300.

Next, method 500 can include a procedure 520 of editing the content of the video. As an example, the user can edit the content of the video and/or add effects. The effects can include audio effects, video effects, or combinations thereof. The editing can be accomplished using, frontend components or backend components. An example of editing can include editing the length of the clip. The front end components can be the same as or similar to front end components 160 and the back end components can be the same as or similar to back end components 105. Further examples of editing can comprise adding voice annotations or narrations, adding speech bubbles; adding text; stitching together more than one video, altering the audio track; adding images to the clip; etc.

Method 500 can further comprise a procedure 530 of adding comments. A user can use a device to add comments to the video clip that has been delivered to the user's device and may have been edited. A user can choose to comment on the video, which will be shared with other users.

After procedure 530, method 500 can continue with a procedure 540 of selecting other data to include with the video clip. Examples of other data that can be included with the video clip can comprise metadata, social data, and/or web data. Metadata can be added to the video clip using a procedure 546. Social data can be added to the video clip using a procedure 542. Web data can be added to the clip using a procedure 544. The metadata, social data, and web data can be the same as or similar to the data processed by the background processing unit 130 and stored within the metadata database 126.

After any other data has been added to the video clip, method 500 can continue with a procedure 550 of sharing the video clip. In procedure 550, a user can select to share the video clip that has been delivered to the phone, edited, had comments added, had other data added, or combinations thereof. The user can choose to share the video clip on social networking sites (such as, for example, Twitter, Facebook, G+), via email, SMS, or any other methods.

Next, method 500 can proceed with a procedure 560 of seeing comments and other content being shared. During procedure 560, a user can see comments that other users have made with respect to the video. In addition, a user can view other content, which can include video clips uploaded by other users, share by other users. In addition, after a video clip has been shared, more comments and other data can be added by the user or other users with respect to the shared video clip. As an example, after procedure 560 method 500 can continue with procedure 530.

It should be noted that method 500 and its procedures are merely exemplary. Many of the procedures can be rearranged without limiting the scope of the invention. In addition, other procedures not mentioned herein can be included within method 500 and/or procedures mentioned with respect to method 500 do not need to be included.

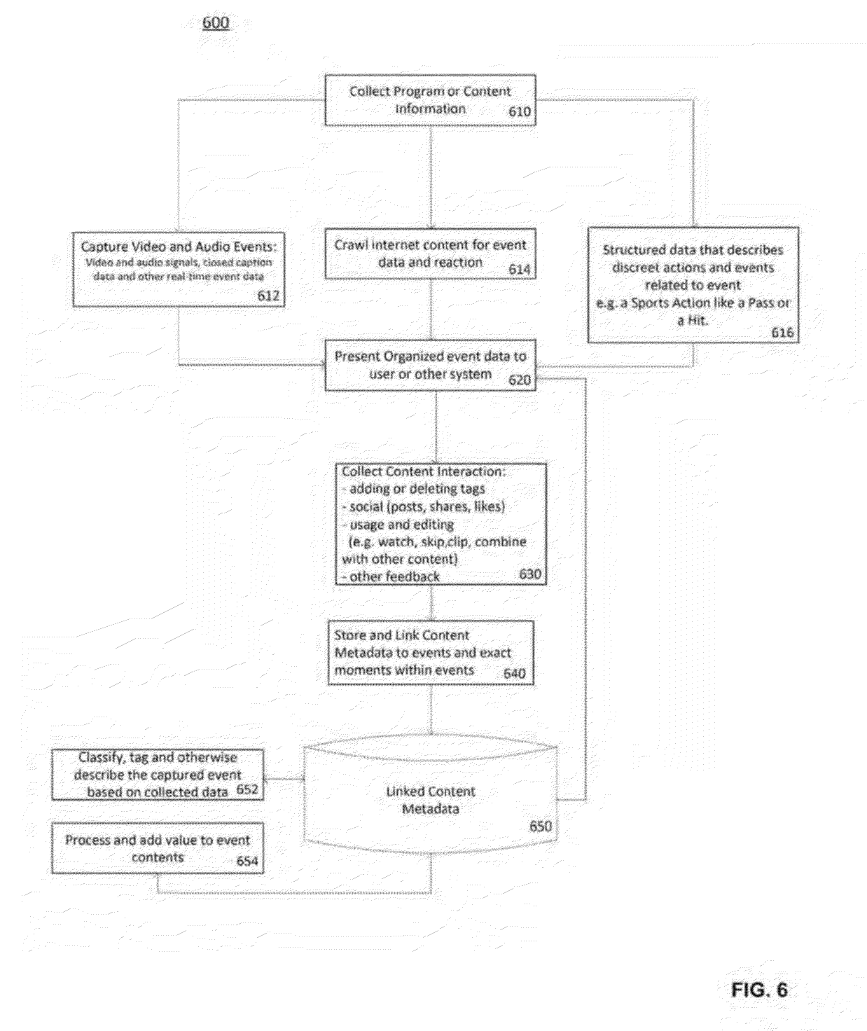

FIG. 6 is a flow chart illustrating an example of a method 600 of collecting event and interaction data. The data collected during method 600 can be the same as or similar to the data added to the video clip during procedure 540 (metadata 546, social data 542, or web data 544) of method 500. Method 600 is merely illustrative of a technique for implementing the various aspects of certain embodiments described herein, and method 600 is not limited to the particular embodiments described herein, as numerous other embodiments are possible. In some embodiments, the various procedures of method 600 can be performed by single computer or a set of computers.

Method 600 has a procedure 610 of collecting program data. The program data can include any program or content information related to a video clip. As an example, video and audio events can be captured during a procedure 612. Audio and video events can include, for example, data related to video and/or audio signals, closed caption data, and other real-time event data.

As another example, Internet content can be captured during as procedure 614 of carling the Internet for vent data and reaction. As an example, the Internet can be mined for comments, data, etc. for information about events. As previously mentioned, events can include, for example, television programs, sporting events, and the like.

As yet another example, structured data can be captured during a procedure 616 of capturing structured data. As an example, structured data can include data that describes discrete actions and events as they relate to a particular event. For example, during a football game, the action may be a pass. As another example, during a baseball game, the action may be a hit.

Method 600 continues with a procedure 620 of presenting organized event data to a user or other system. The organized data can include, for example, the data captured during procedures 612, 614, and/or 616.

Next, method 600 can comprise a procedure 630 of collecting content interaction. The content interaction can include, for example, adding or deleting tags to a video clip, social usage data (posts, shares, likes, etc.), usage and editing data (watches, skips, clips, combinations with other content, etc.), and/or other feedback. Procedure 630 enables the actions of a wide variety of users to inform the system of what is important and happening in the world.

Procedure 640 follows. Procedure 640 is a procedure for storing and linking content metadata to events and exact moments during a particular event. For example, a touchdown may occur during a particular point during a football game. Procedure 640 allows a video clip to have an exact time in which said touchdown occurred. In addition, other data can be added to any clip. As shown in FIG. 6, the data is stored in 650. In some embodiments, the data can be stored in a database that is the same as or similar to metadata database 126.

Method 600 can continue back to process 620. This allows more and more content to be added to any individual clip. This allows for a robust collection of clips with all sorts of data attached to them.

After 650, method 600 can include a procedure 652 and/or as procedure 654. Procedure 632 can comprise classifying, tagging, and/or otherwise describing the captured event based on the data that has been collected during method 600. Procedure 654 can comprise processing and adding value to event contents.

In addition, data related to any particular video clip can include Digital Rights Management (DRM) data. For example, certain clips may be limited to a certain type of user, such as, for example, a premium user. A copyright holder may only allow a certain number of their clips to be shared, edited, etc. The systems and procedures of the present invention allow for management of DRM issues.

It should be noted that method 600 and its procedures are merely exemplary. Many of the procedures can be rearranged without limiting the scope of the invention. In addition, other procedures not mentioned herein can be included within method 600 and/or procedures mentioned with respect to method 600 do not need to be included.

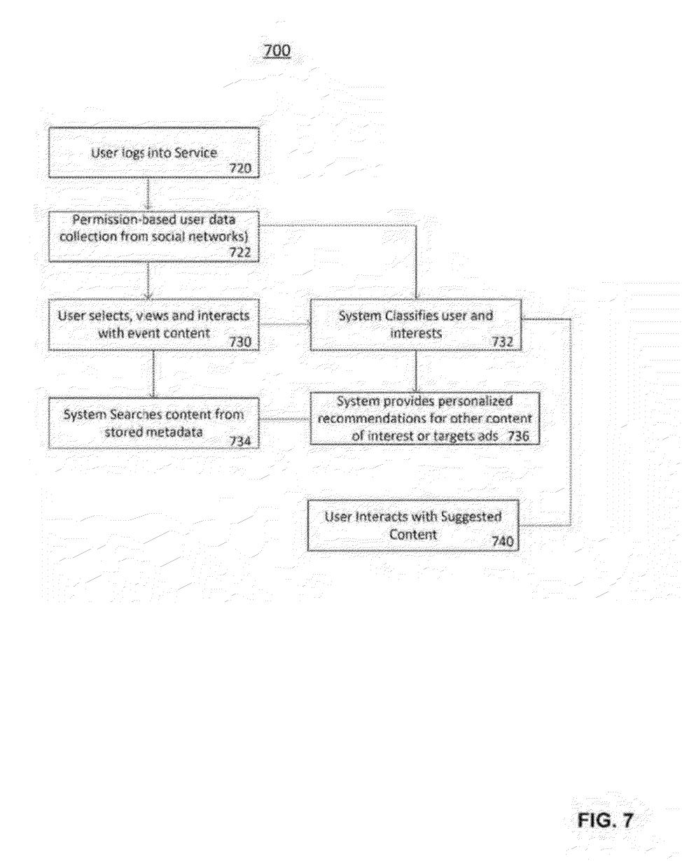

FIG. 7 is a flow chart illustrating an example of a method 700 of recommending content. Method 700 can be considered a method for informing a user of content that a user may be interested in. Method 700 is merely illustrative of a technique for implementing the various aspects of certain embodiments described herein, and method 700 is not limited to the particular embodiments described herein, as numerous other embodiments are possible. In some embodiments, the various procedures of method 700 can be performed by single computer or a set of computers.

Method 700 comprises a procedure 720 of a user logging into a particular service. An example of the service can include LiveMagic™ services. Method 700 continues with a procedure 722 of collecting user data from social networks. In some examples, the service app that a user has signed into will gain authorization from other social networks for access to the user's account at the other social networking sites.

Method 700 continues with a procedure 730 of a user selecting, viewing, and/or interacting with event content. Method 700 also comprises a procedure 732 of the system classifying users and their interests. This can be done in at least part based on the history of the user and the content they search, view, and interact with. In addition, any additional data associated with any event clips, such as, for example, metadata can also be instrumental in classifying a user's interest.

Method 700 also comprises a procedure 734 of searching for content from stored metadata. Furthermore, from this search, which may me similar to or the same as aspects of the example of FIG. 6, method 700 can continue with a procedure 736 of providing personalized recommendations of content that the user may enjoy. In addition, the system can also present targeted advertisements to the user based on the user's likes and interests.

Next, procedure 700 can comprise a method 740 of the user interacting with the suggested content. The systems is able to further gage the user' interested by how the user interacts with the suggested content.

It should be noted that method 700 and its procedures are merely exemplary. Many of the procedures can be rearranged without limiting the scope of the invention. In addition, other procedures not mentioned herein can be included within method 700 and/or procedures mentioned with respect to method 700 do not need to be included.

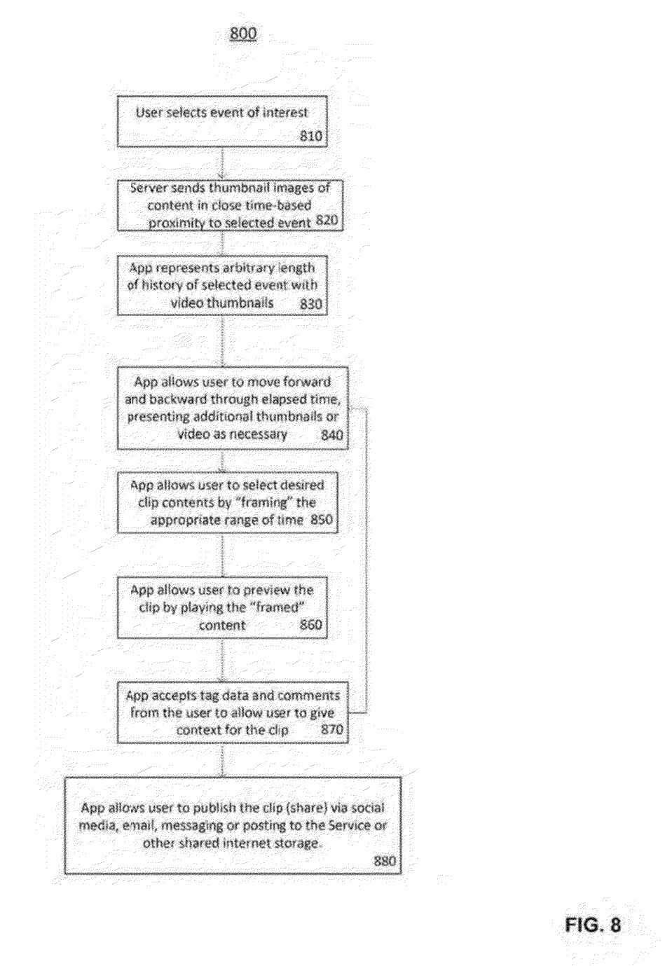

FIG. 8 is a flow chart illustrating an example of a method 800 of creating clips. Method 800 can be considered a method for creating video clips for a user. Method 800 is merely illustrative of a technique for implementing the various aspects of certain embodiments described herein, and method 800 is not limited to the particular embodiments described herein, as numerous other embodiments are possible. In some embodiments, the various procedures of method 800 can be performed by single computer or a set of computers.

Method 800 can comprise a procedure 810 of a user selecting an event of interest. Procedure 810 can be the same as or similar to method 300 of FIG. 3.

Method 800 continues with a procedure 820 of sending images to the user regarding the chosen event. In some example, the server sends thumbnail images of the content in close time-based proximity to the selected event.

Next, method 800 continues with a procedure 830 of representing an arbitrary length of history of the selected event with video thumbnails. For example, the user can be presented with a series of video thumbnails, each comprising an arbitrary length of time. This length of time can be a few second, 30 seconds, or even a couple of minutes. It should be noted that any arbitrary length or time can be selected.

Method 800 can further comprise a procedure 840 of allowing the user to move forward or backward through elapsed time. In some examples, the procedure 840 allows a user to be presented with additional thumbnails as necessary to find the desired range of thumbnails for the user's chosen content. For example, the user has chosen a football game event. However, the user wants to view something from the first quarter of the event, but the user didn't detect the event until the third quarter of the football game. Since considerable time has passed, the user will be able to be presented with more and more thumbnails of videos until the user gets to the time period in which the user was interested.

Next, method 800 comprises a procedure 850 of allowing a user to select a desired clip contents by framing the appropriate range of time. As an example, the user may want to have clip from a particular starting action to a particular ending action. As such, the user can then choose what that starting action is and what the ending action is, and creates a clip that lasts that time period.

Method 800 continues with a procedure 860 of allowing the user to preview a clip by playing the framed content chosen during procedure 850. This allows as user to make sure that he or she has framed the right content to create an appropriate clip.

After 860, method 800 continues with a procedure 870 of accepting tag data and/or comments from the user with respect to the clip. The user can add comments and/or data as previously discussed. This provides more information to the clip for future use, classification, etc.

Next, method 800 comprises a procedure 880 of allowing a user to share or publish the clip. As previous discussed, this can include sharing via social networks, email, SMS, social media, posting to a LiveMagic™ service, or other similarly shared internet storage.

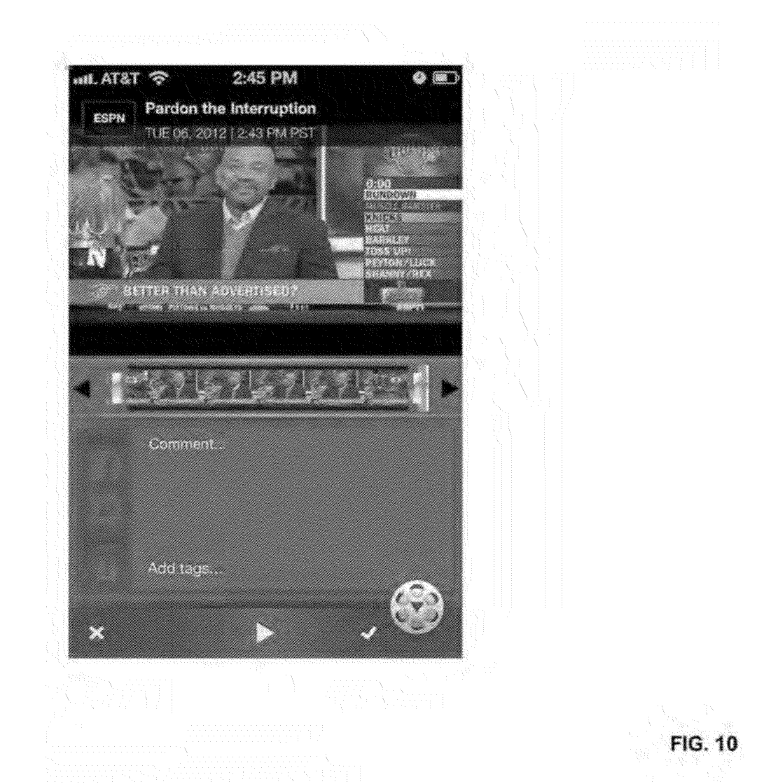

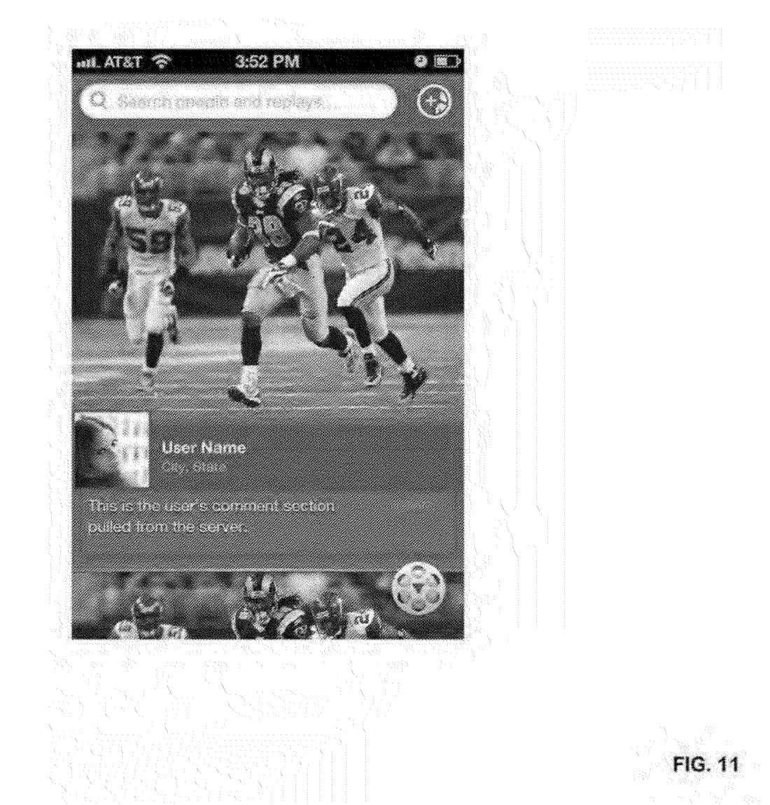

As examples, FIGS. 10 and 11 illustrate examples of screen shots of a mobile device displaying one or methods according to an embodiment. In particular, FIGS. 10 and 11 can be seen as examples of screen shots of a mobile device displaying a method of creating clips.

It should be noted that method 800 and its procedures are merely exemplary. Many of the procedures can be rearranged without limiting the scope of the invention. In addition, other procedures not mentioned herein can be included within method 800 and/or procedures mentioned with respect to method 800 do not need to be included.

According to further embodiments of the present invention, the systems and methods presented herein allow a user to view video clips on a mobile device in a resolution that is suitable for said device. However, such resolution may be less than what a user would like to share on a social network. For example, a user may prefer to view video on his or her mobile device in standard definition (SD). For example, a user may wish to view SD on his or her mobile device due to bandwidth or resolution issues on the mobile device. However, when on a computer or on an Internet enabled television, a user may prefer to view the clips in high definition (HD). As such, in the embodiments presented herein, a user can view, edit, comment on, and share a clip on a mobile device on which the user is viewing the video in SD. However, once the clip is uploaded to another site, the clip is uploaded in HD.

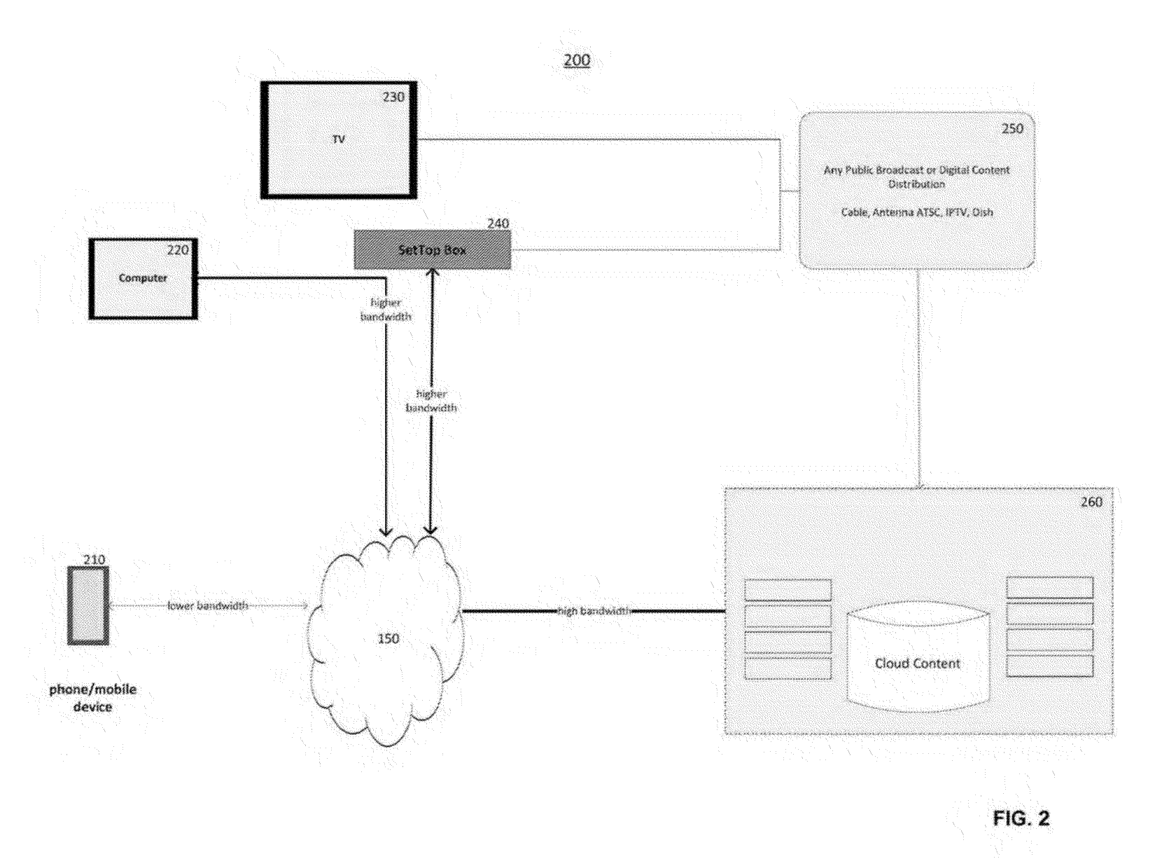

FIG. 2 illustrates an example of a system 200 for streaming content, according to an embodiment. In the same or different embodiments, system 200 can be a digital video recorder (DVR) system for streaming content and user interaction. System 200 is merely exemplary and is not limited to the embodiments presented herein. System 200 can be employed in many different embodiments or examples not specifically depicted or described herein.

System 200 can be the same as or similar to system 100. System 200 can comprise a mobile device 210, a computer 220, a television 230, a set-top box 240, and content distributors 250. Mobile device 210, computer 220, television 230, set-top box 240, and content distributors 250 can be the same as or similar to front end components 160 of FIG. 1.

Furthermore, system 200 can comprise a network 150. In addition, system 200 can comprise backend components 260. Backend components 260 can be the same as or similar to backend component 105 of FIG. 1.

As illustrated in FIG. 2, mobile device 210 may communicate with network 150 at a lower bandwidth than computer 220, set-top box 240, or backend components 260. This may be because mobile device 210 is communicating with network 150 through a cellular connection. Since, the video is uploaded to any cites from backend components 260, rather than the phone directly, the video uploaded anywhere can be HD. In addition, if the backend components 260 detect that a user is on a mobile device, in some examples, it may upload video clips to the device in SD. However, if it is acceptable for the mobile device to receive HD video, then the system will allow that too.

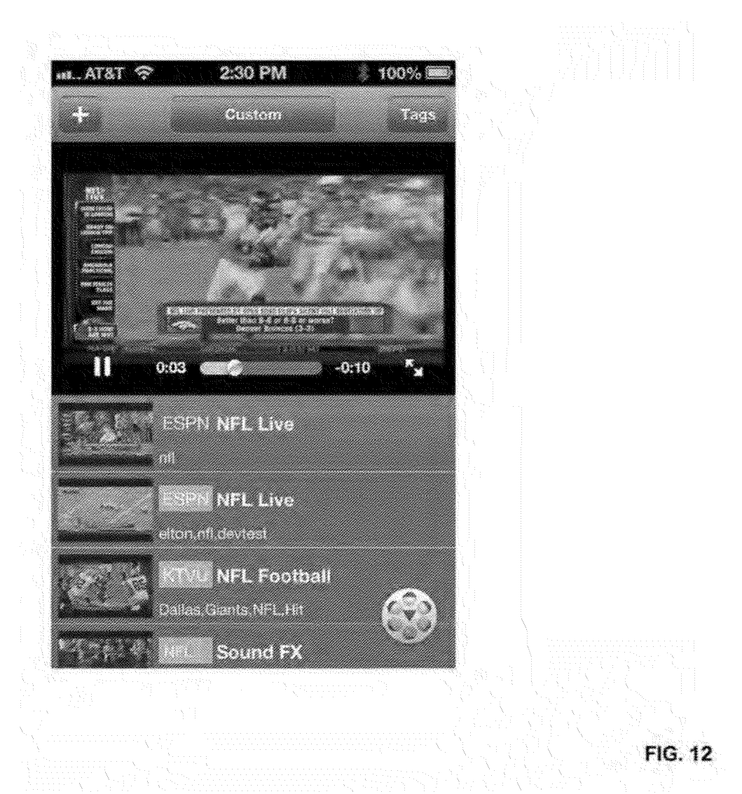

As an example, FIG. 12 illustrates an example of a screen shot of a mobile device displaying one or methods according to an embodiment. In particular, FIG. 12 can be seen as an example of a screen shot of a mobile device replaying a clip.

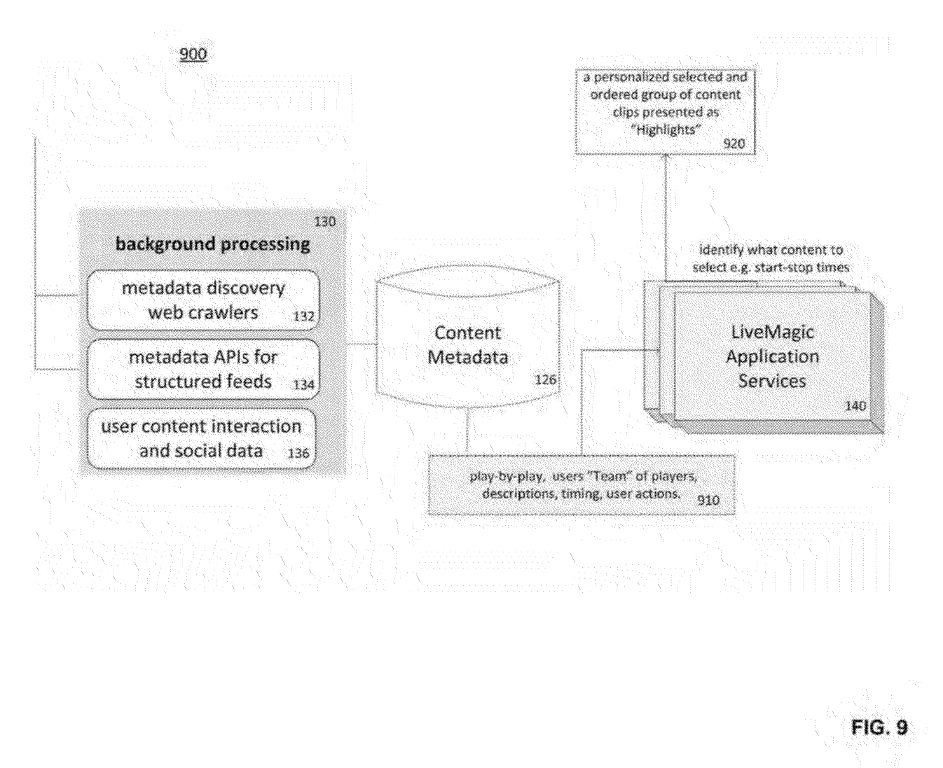

FIG. 9 illustrates a system 900 for creating an automated playlist, according to an embodiment. In the same or different embodiments, system 900 can be a system for creating a fantasy sports playlist. System 900 is merely exemplary and is not limited to the embodiments presented herein. System 900 can be employed in many different embodiments or examples not specifically depicted or described herein. System 900, in some embodiments, can be considered to be a portion of system 100 of FIG. 1.

As shown in FIG. 9, system 900 can include a background processing unit 130, a metadata database 126 and an application services unit 140. System 900 also includes metadata related to a particular interest of a user. For example, a user may have a fantasy football team. Therefore, the metadata may comprise the names of the players on the user's fantasy football team. Therefore, using the methods and systems previous discussed herein, system 900 can send selected content 920 to frontend components. Content 920 can include a personalized selected and ordered group of content clips presented as “highlights” to the user. As an example, content 920 can include all of the highlights from any player on a user's fantasy football team. It should be noted that system 900 can be used for examples other that fantasy sports. For example, a user can create a list of his or her favorite athletes or favorite sports teams. In addition, a user could create a list of his or her actors. There are numerous possibilities of the types of lists that a user can create.

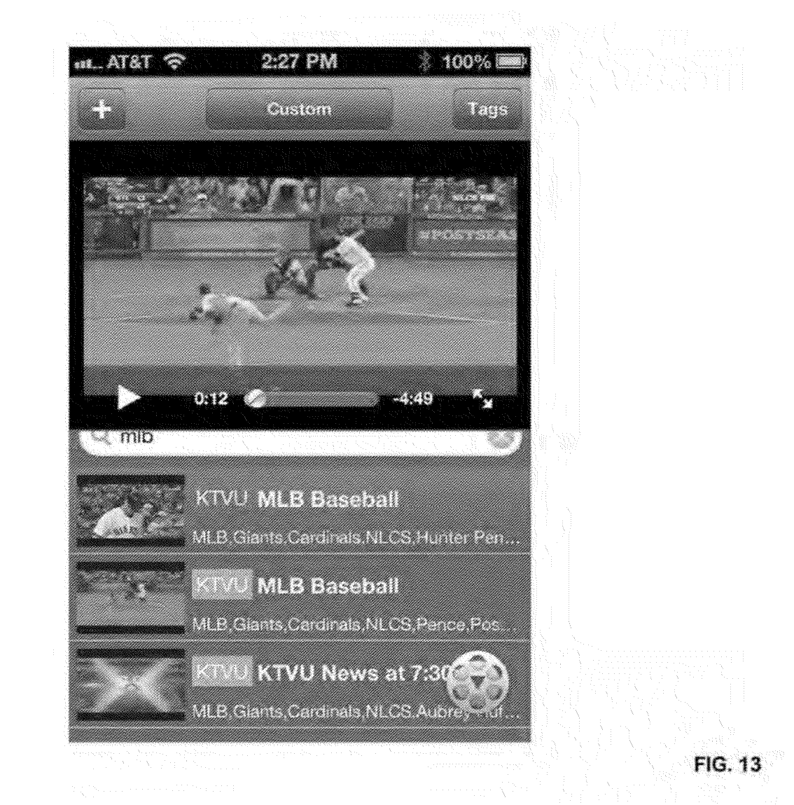

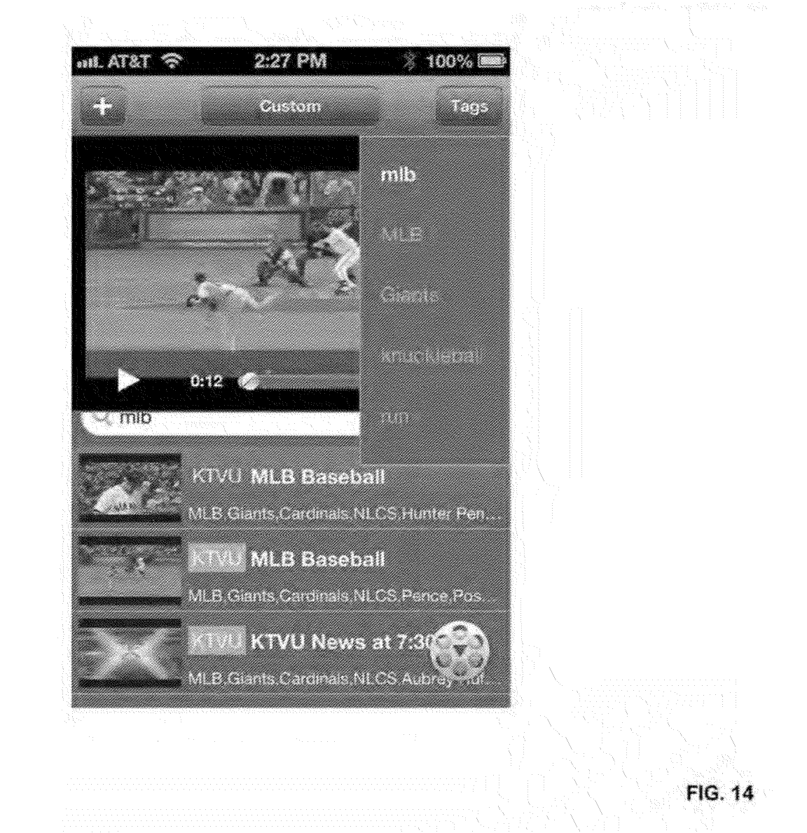

As examples, FIGS. 13 and 14 illustrate examples of screen shots of a mobile device displaying one or methods according to an embodiment. In particular, FIGS. 13 and 14 can be seen as examples of screen shots of a mobile device displaying highlights according to at least one embodiment. FIG. 13 shows an example of a highlight without tags and FIG. 14 shows an example of a highlight with tags.

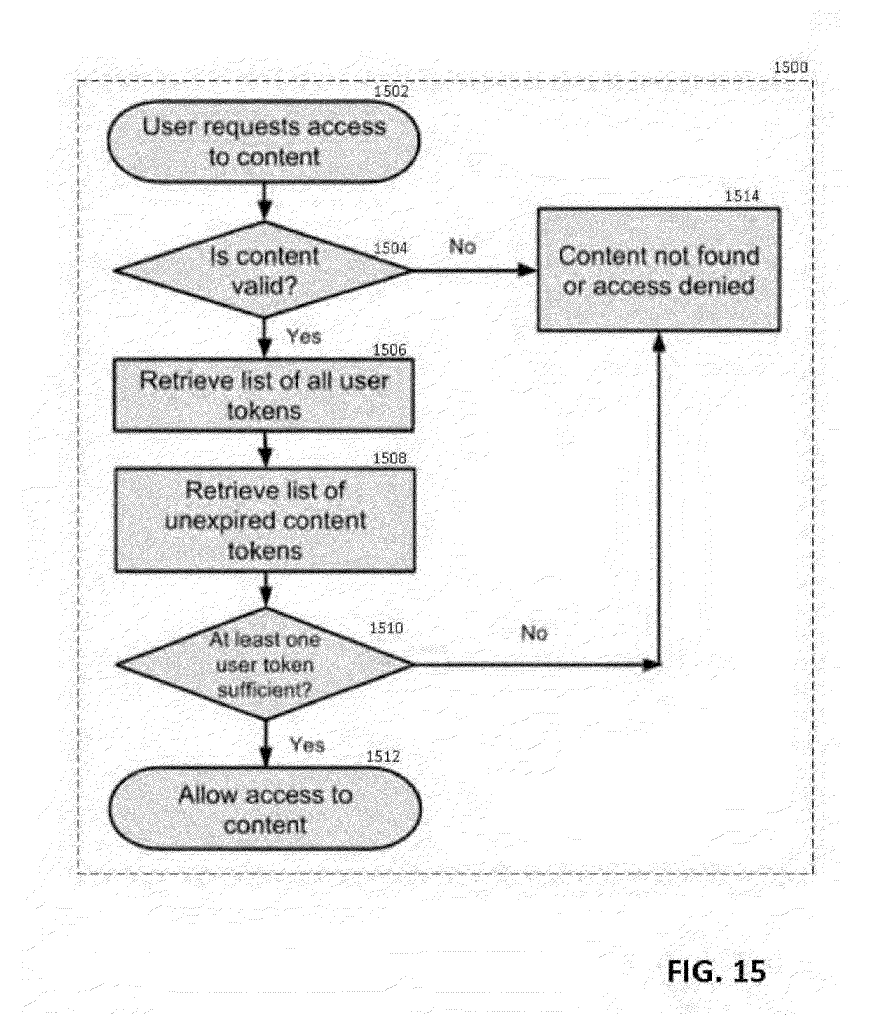

In the embodiment shown in the exemplary flowchart of FIG. 15, a method 1500 for accessing content is described. Users are granted access to content via the following procedures: 1502 the user requests access to content; 1504 the system determines if the content is valid; 1506 the system retrieves a list of all the available user tokens; if the content cannot be found or access to the content has been denied 1514 the content will be deemed invalid; if the system determines that the content is valid, 1508 the system will retrieve a list of acceptable user tokens and content tokens; 1510 if at least one of the user tokens is deemed sufficient, 1512 the system will grant access to the content.

It should be noted that method 1500 and its procedures are merely exemplary. Many of the procedures can be rearranged without limiting the scope of the invention. In addition, other procedures not mentioned herein can be included within method 1500 and/or procedures mentioned with respect to method 1500 do not need to be included.

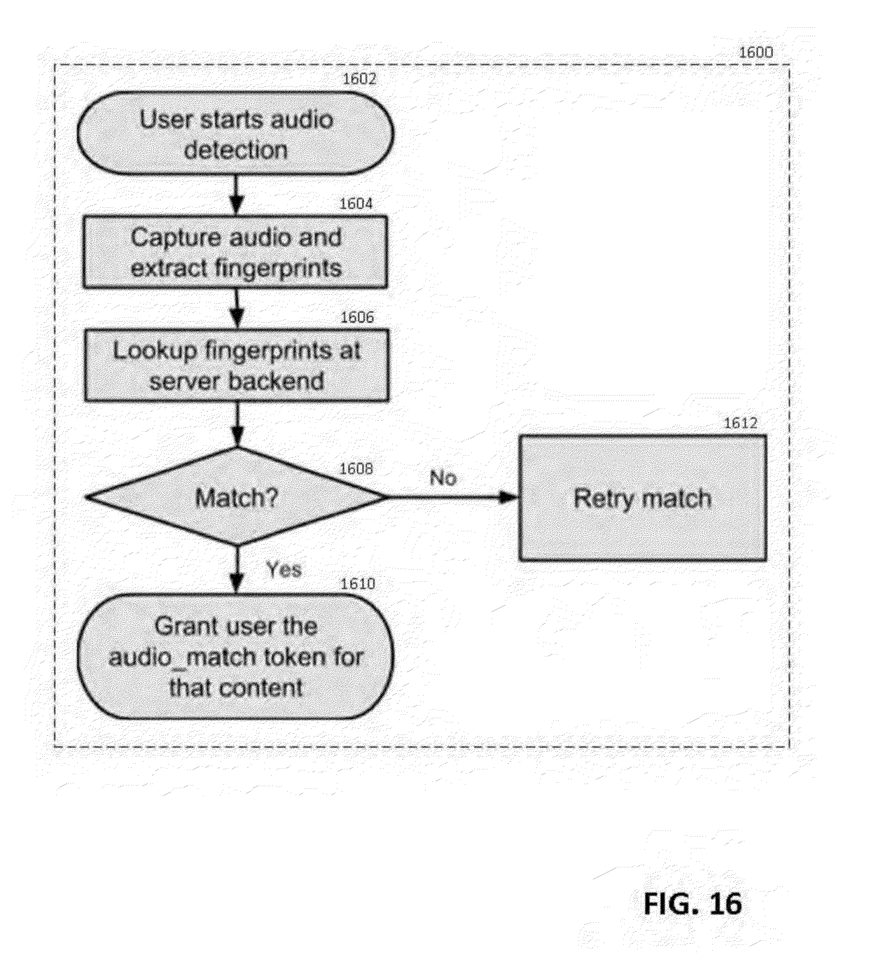

FIG. 16 shows an example of a method 1600 for granting tokens via audio fingerprinting. As an example, user tokens can be updated when a user successfully matches a program. The user starts audio detection 1602 and the system captures audio, extracts 1604, and looks up the fingerprints at the server backend 1606. If a match of the fingerprint is found, the user will be granted an audio match token for the detected content 1610.

It should be noted that method 1600 and its procedures are merely exemplary. Many of the procedures can be rearranged without limiting the scope of the invention. In addition, other procedures not mentioned herein can be included within method 1600 and/or procedures mentioned with respect to method 1600 do not need to be included.

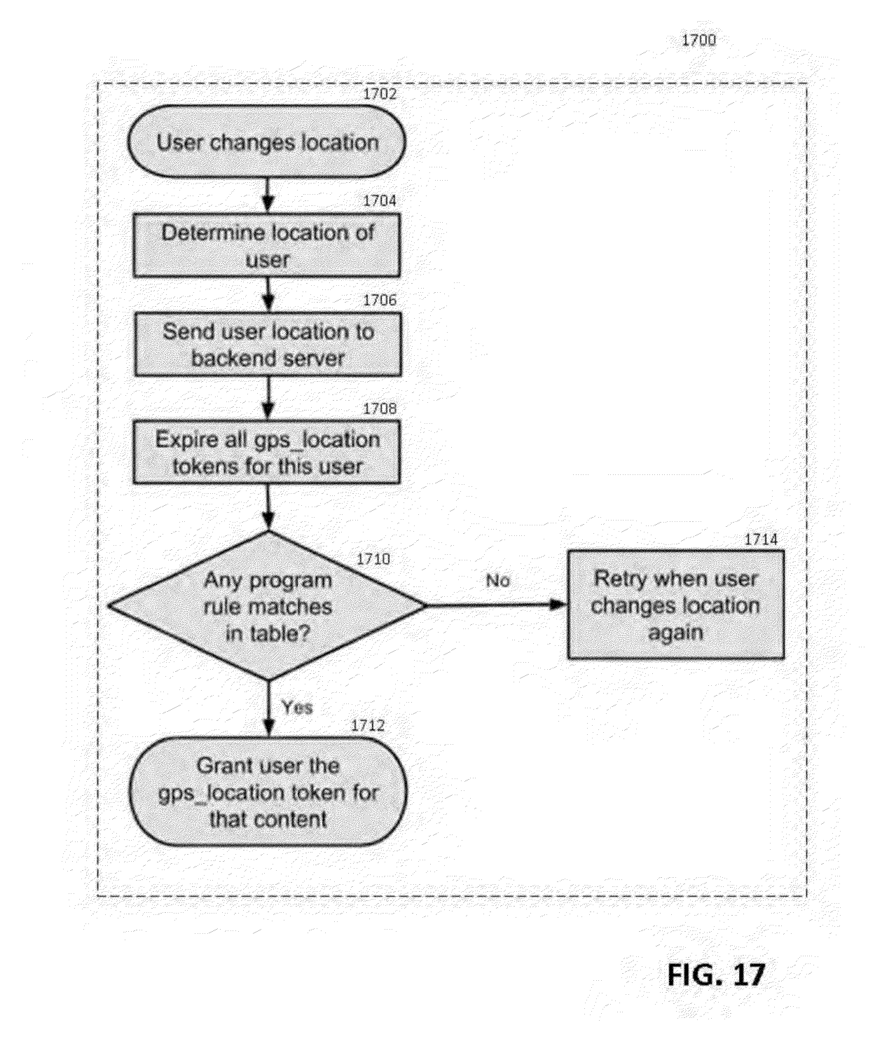

In the embodiment shown in the example of FIG. 17, a method 1700 for updating user tokens when a user changes location is described. When the user changes location 1702, the system determines the location of the user 1704 and sends the user's location data to the backend server 1706. As an example, the user's location can be determined using GPS function of the user's mobile device. It should be noted that other ways of determining a user's location can be used, such as, for example, using the user's Wi-Fi connection to determine location. This can cause all or some of the Global Positioning System (GPS) tokens currently held by the user to expire 1708. If there is a content match in the rules table on the backend server 1710, the user will be granted a token for the matched content 1712. If no content match is found in the rules table on the backend server, the system can retry the process when the user changes location 1714.

It should be noted that method 1700 and its procedures are merely exemplary. Many of the procedures can be rearranged without limiting the scope of the invention. In addition, other procedures not mentioned herein can be included within method 1700 and/or procedures mentioned with respect to method 1700 do not need to be included.

Embodiments of the present invention, can comprise application enabling a user to preview a short video “Scene” and capture a small segment, or “Clip” from that Scene, both short segments from an on the air now television program (“Program). In some examples the app can be an application on a smart phone, tablet, or the like. In the same or other examples, the television program can be delivered by a broadcast or cable/satellite service provider, or from a stored on-demand video or other method.

In the same or other embodiments, a user can use a device, such as, for example, a mobile phone or a tablet device, etc., to capture and share a short segment of a TV program “a Clip” of an event they are simultaneously watching from their TV service provider, for example cable, satellite, or over the air, etc. The event can comprise, for example, a television program, a movie, streaming video content, (e.g., a sporting event, a concert, a play, etc.) and is delivered to a device as a series of images (thumbnails) depicting Scenes in time sorted order from most recent to least recent. It should also be noted that specific types of TV programs not mentioned above can also be captured. In addition, as mentioned elsewhere, events can also be captured. In addition, the apps mentioned herein can run on devices other than smart phones or tablets, such as, for example, a computer.

According to embodiments of the present invention, the user can select a TV program “Program” and then be presented with different “Scenes” from such program, and then edit within the Scene to capture a smaller segment or “Clip” to share within the client application and/or on social networks, such as, for example Facebook and Twitter, etc. In one embodiment a ‘Scene’ is a short segment (30-120 seconds) of as TV-Program created by a user and as ‘Clip’ is an even shorter segment of a Scene selected by the user (1-30 seconds). It should be noted that different time frames not specifically mentioned herein can be used to define a Scene and/or Clip.

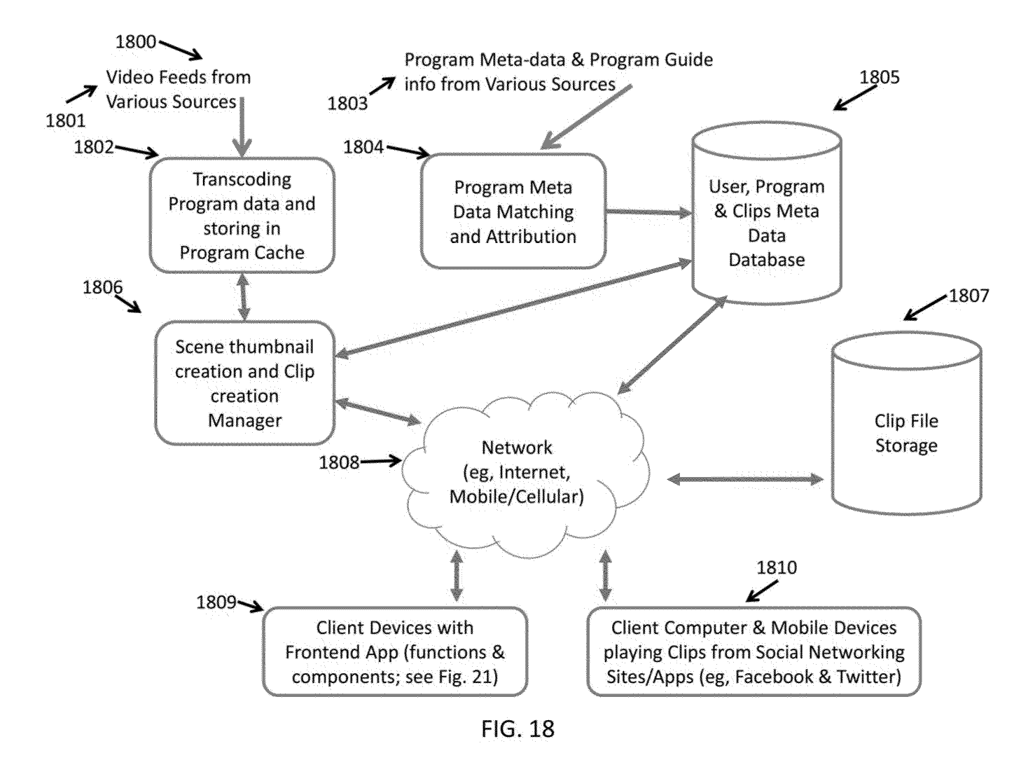

Turning to the drawings, FIG. 18 illustrates an example of a system 1500 for creating and viewing Clips in a networked environment, according to an embodiment. System 1800 can also be considered a system for creating and viewing Clips in a mobile and a networked environment. System 1800 is merely exemplary and is not limited to the embodiments presented herein. System 1800 can be employed in many different embodiments or examples not specifically depicted or described herein.

According to some embodiments, system 1800 can comprise of a backend and a frontend. In these embodiments the frontend can comprise apps that run on consumer devices such as, for example, mobile phones and tablets, etc. The backend can be separate computing systems (processes) accessed by the frontend through APIs (Application Programming Interfaces). Such a backend could be considered a “cloud computing service”. Such backend processes can be used for content/Program acquisition 1801, 1802, 1803, 1804 and 1805, Clip creation, Clip posting, and Clip viewing 1805, 1806 and 1807. Backend components can be the same as or similar to those described previously herein.

With continued reference to FIG. 18, system 1800 can include a network 1808. As an example, network 1808 can comprise the Internet and/or a cellular telephone/data network. In other examples, network 1808 can comprise a network specifically created for the systems and methods discussed herein.

System 1800 also includes frontend components that reside on client devices in as client application 1809 such as a mobile smart phone or tablet, etc. Frontend functions/components can include, for example, selecting a Program, selecting a Scene from the Program from which to make a Clip; user controls for zooming and editing Scenes into Clips and then posting the Clip. Each of the frontend components 1809 is connected to the backend components via the network 1808. Additional Client devices/functions 1810 are also supported for playing Clips. Frontend components can be the same as or similar to those described previously herein.

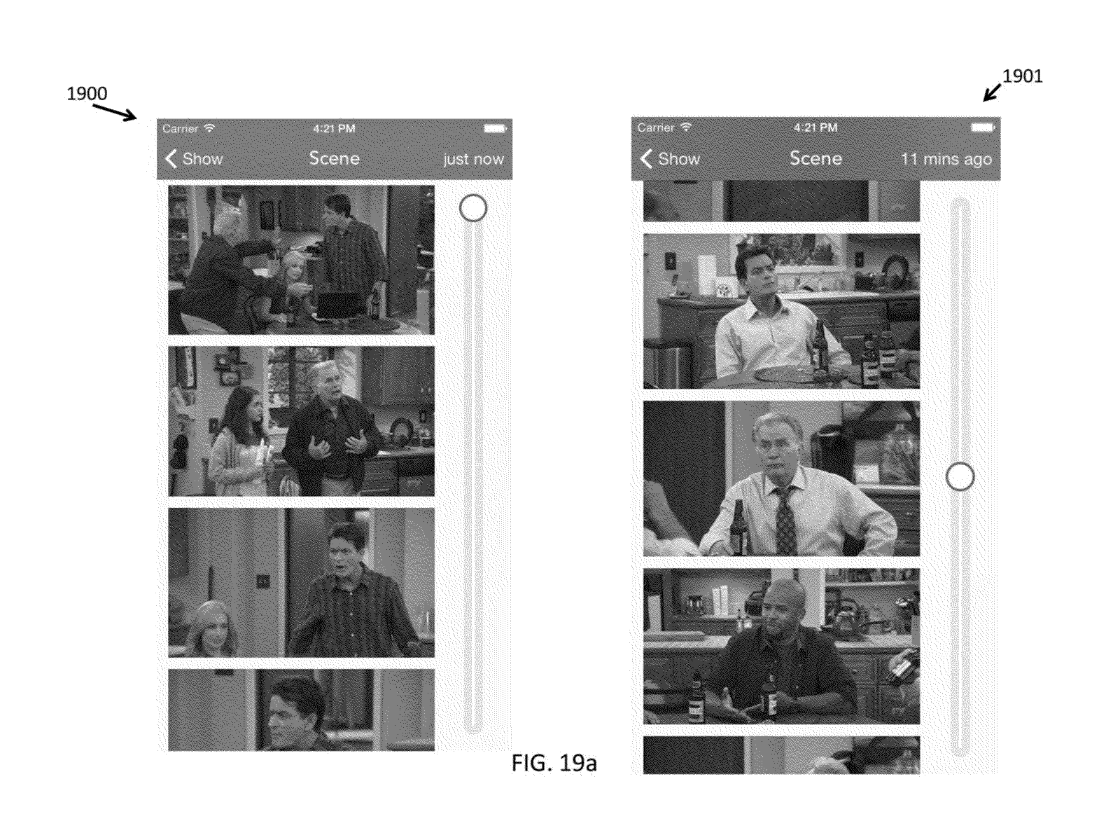

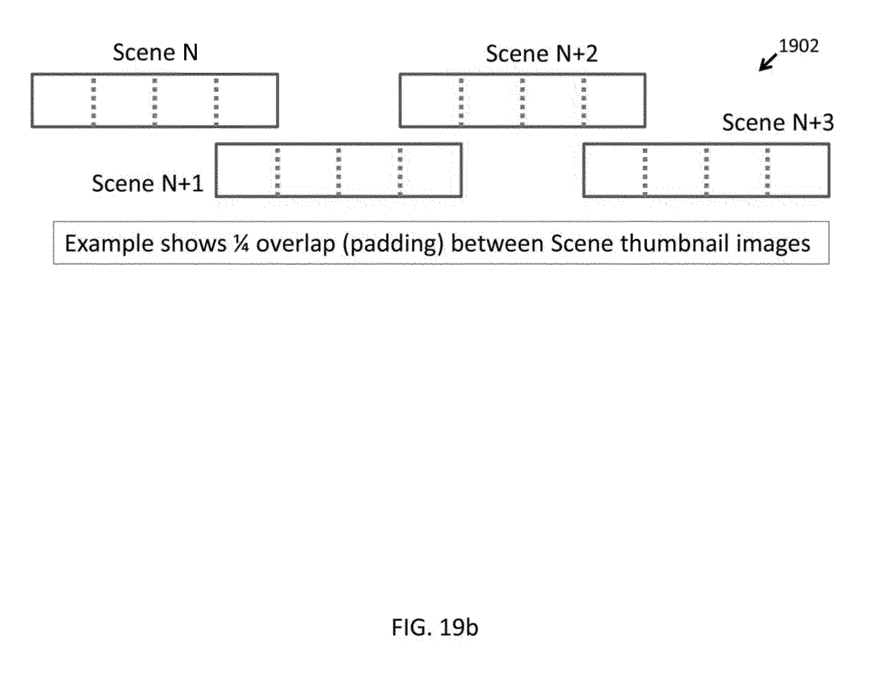

FIGS. 19a and b depict how, once a program is selected, thumbnail images of various Scenes from the program are shown to the user and how the user can scroll back in time to older Scenes from the program. In one embodiment such Scenes are shown in linear order by most recent on top to less recent on the bottom. In another embodiment, as illustrated in FIG. 19b, such Scenes may overlap (“Padding”) such as Scene-3 also includes the last ¼ of Scene-2 and the first quarter of Scene-4. This “Scene-method” means, a) it takes looking at only 2 Scenes to find the right Scene to make the Users desired Clip, b) all possible Clips are easily findable, and c) a user can only clip the max Clip length of a desired Program segment in one Scene. This enables 1) the user to more easily find his or her desired segment since there are minimum decision points, and 2 does not allow them to easily play the program ensuring the App/Service cannot be used to redistribute or retransmit the program. FIG. 19a shows a user scrolling down to find his or her desired Scene between screen shots 1900 and 1901.

According to some embodiments, the Scene-method avoids the need to download or stream significant amounts of content thus reducing process latency and significantly lowering network bandwidth required between the backend service and the frontend mobile application.

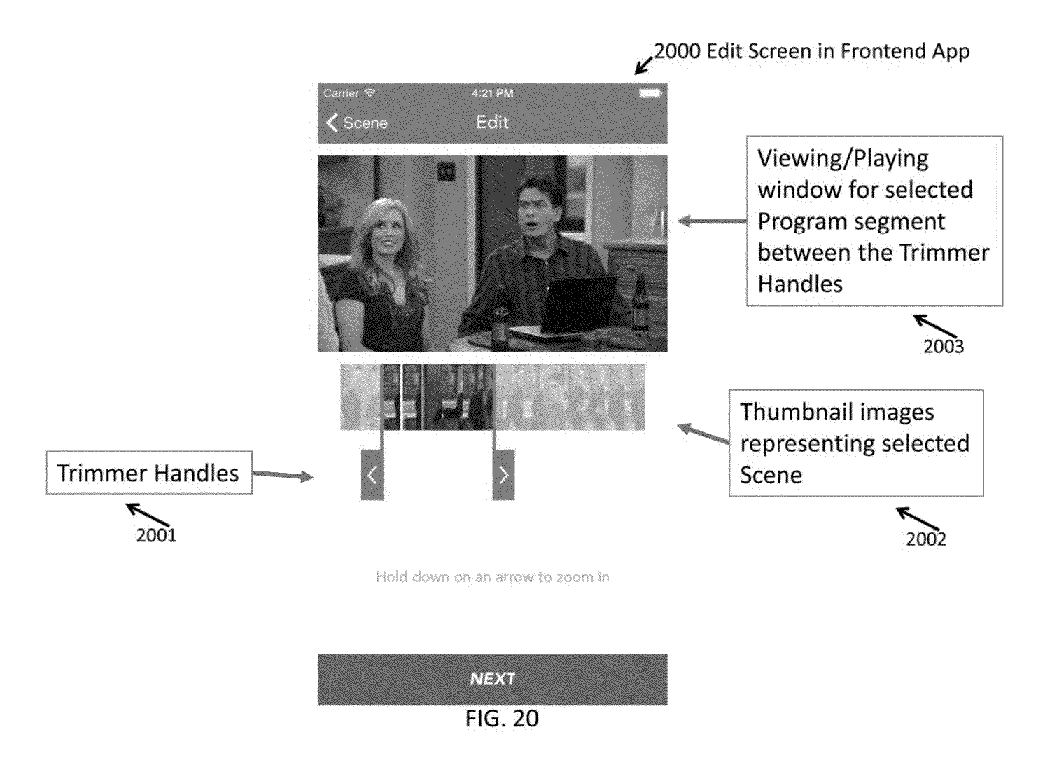

According to some embodiments, once a Scene is selected, the entire Scene appears in the editing stage of the Clip creation process as a series of still image “thumbnails.” As examples, these thumbnails can be jpegs, gifs, etc. It should be noted that other file types not specifically mentioned can also be used. FIG. 20 illustrates an example of a screen shot in which these thumbnail images are shown during the editing stage. 2002 illustrates an example of the thumbnails.

According to some embodiments, the thumbnails within a Scene process enables virtually frame accurate editing/selection of the start and stop points of the desired created Clip.

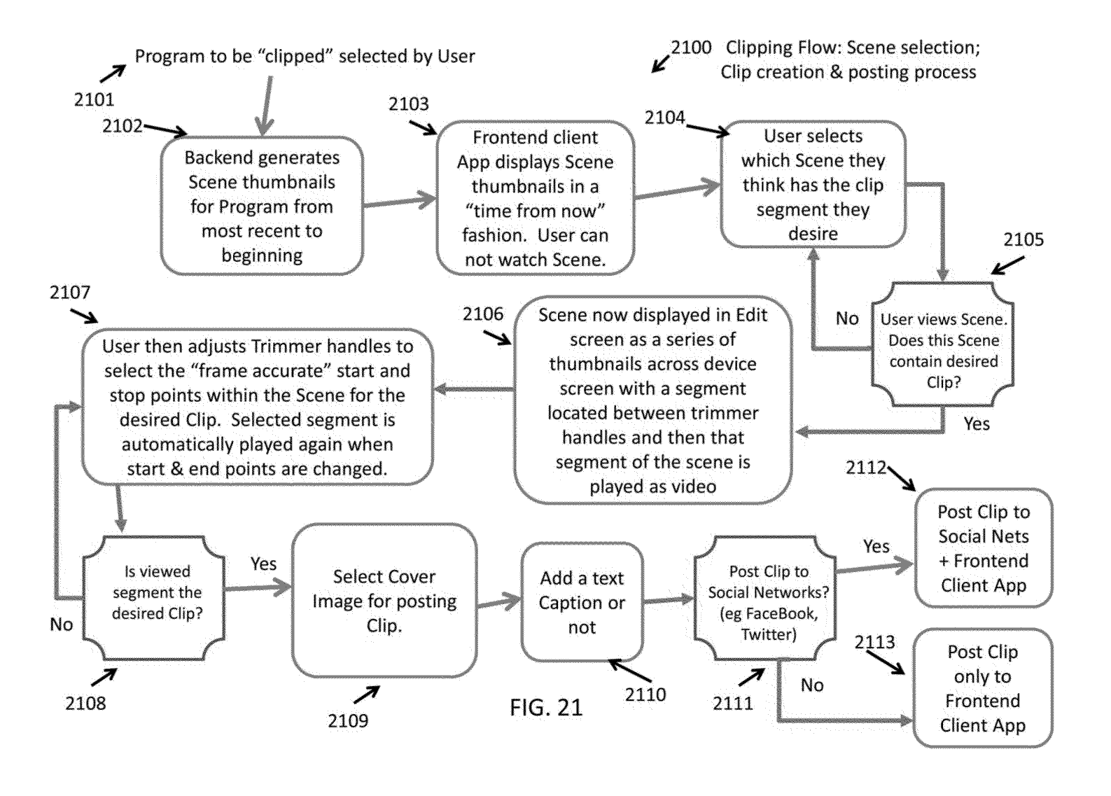

FIG. 21 is an example of a flowchart that demonstrates a method 2100 for a user with a Frontend App to create a Clip. The method comprises delivering thumbnail previews Of Scenes to the device during editing without having to download the selected Program. Delivering thumbnail preview can comprise, for examples, procedures 401, 402, 403, 40, and 405. It also demonstrates how lists of Scenes from a selected program appear on a mobile device. Each Scene clip can comprise an overlap of content from the previous Scene clip segment and from the next Scene clip segment to ease user ability to capture an intended clip segment. Method 400 also discourages the user from attempting to watch a program continuously as the repeat of content at the beginning and end of each clip segment represents a disjointed viewing experience. Furthermore, procedures 2106-2113 illustrate how to select a scene, edit a clip, and post the clip to a choice of social media sites and/or client apps.

FIG. 20 illustrates a screenshot 2000 of trimming and editing a Scene to create a Clip using the trimmer handles on a mobile device, according to an embodiment. The user can capture a desired Clip segment by only adjusting the time value of the handle(s) 2001 selected by the user, either at the beginning or left most trimmer handle, or the ending or right most trimmer handle. For example, the user can select the left trimmer handle or right and lengthen or reduce the length of the beginning or end of a video clip without affecting the time value of the unselected trimmer handle (networked based zoom.)

FIG. 20 depicts thumbnail images 2002 derived from video clips delivered as a thumbnail image strip on a mobile device to enable a user to identify and request a video clip segment from a Scene without requiring the entire video clip Scene content to be available for viewing. FIG. 20 also illustrates a window 2003 for viewing/playing a selected program segment represented between trimmer handles 2001.

In some embodiments, the editing screen of FIG. 20 can comprise an option for a user to zoom in on the selected scene more than depicted in the example of FIG. 20. For example, a user could hold down an arrow on one of the trimmer handles 2001. This action can produce a second series of thumbnail images. This second set of thumbnail images would represent the scene selected with a greater amount of detail. As an example, there may be 1 thumbnail image 2002 for every 1 second of the scene. Furthermore, if the user chooses to zoom in to get an even more particular starting point or end point for the created clip, the second set of thumbnail images (not shown) may be present in the rate of 10 thumbnail images per 1 second of scene. It should be noted that the number of images per second of scene depicted above are only examples, and that a greater or less number of images per second can be used for the thumbnail images and/or the secondary thumbnail images.

One embodiment of the present invention calculates the ideal maximum clip duration, by using the screen size of the device in the calculation. The Scene duration is the width of the screen, then the maximum clip length is determined to be half of the Scene length, leading to the most optimized presentation on the device for efficient editing and selection of the precise segment the User desires.

Further explaining the embodiment of calculating the ideal maximum clip duration, c, relative to the device screen size, which is completely defined by inputs:
Where,
t represents thumbnail width;
h represents trimmer handle width;
v represents viewport (or screen) width;
i represents time interval.

Further explaining the embodiment of calculating the ideal maximum clip duration, the number of thumbnails that appear in the viewport, n, is defined as:

$$n = \frac{v - 2 h}{t}$$

Further explaining the embodiment calculating the ideal maximum clip duration, the time interval of a Scene, s, is defined as:

S=in

Further explaining the embodiment of calculating the ideal maximum clip duration, the Padding, or the amount of time in excess, p, is defined as:

p=s−c

Further explaining the embodiment of calculating the ideal maximum clip duration, c, is intended to be exactly, c, to display only as many Scenes as necessary, is defined as:

p=s−c

c=s−c

2c=s

Thus, c is defined as:

$$c = \frac{s}{2}$$

Expanding c, the result is:

$$c = \frac{s}{2}$$

$$c = \frac{in}{2}$$

$$c = \frac{i ( \frac{v - 2 h}{t} )}{2}$$

Further explaining the embodiment of calculating the ideal maximum clip duration, fidelity and accuracy improves to provide more thumbnail images within the same Scene length, creating a sensitive and accurate thumbnail time representation for user selection.

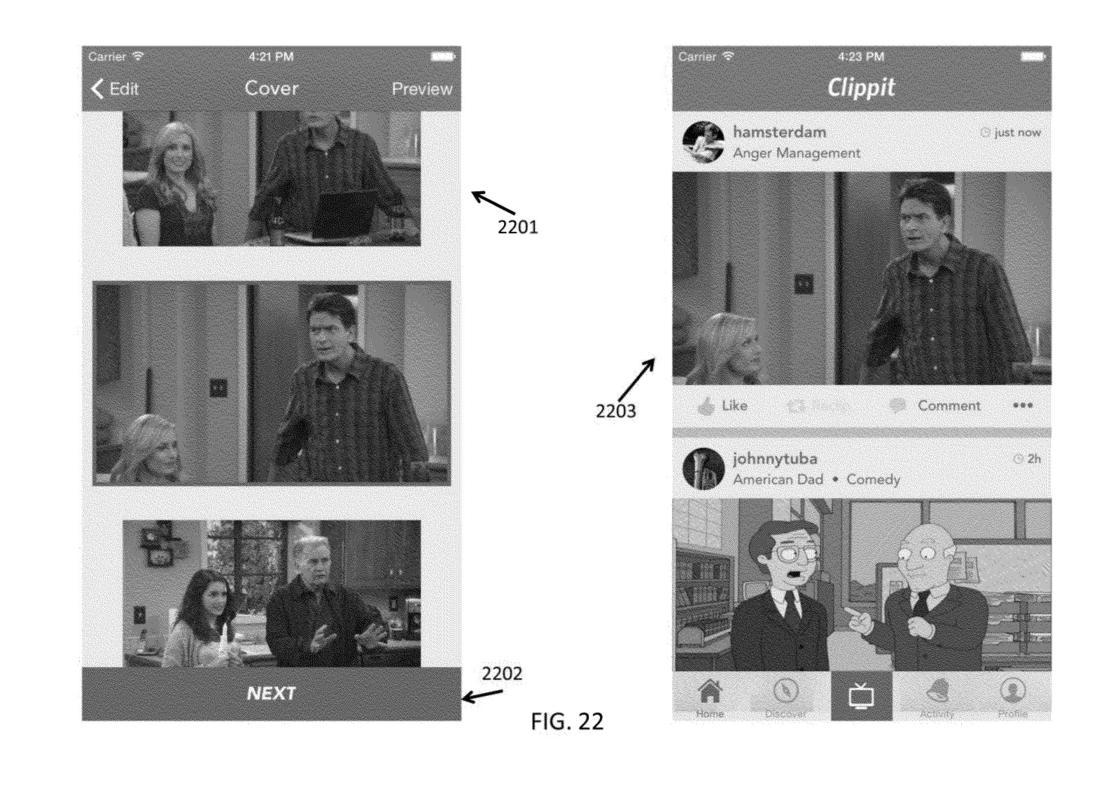

With continued reference to the figures, FIG. 22 illustrates how a still image “cover” thumbnail is selected by moving the desired still image to the center of the screen 2201, which is automatically selected when the user clicks on the “next” button 2202. 2203 illustrates an example of how the cover image is then used when posting the Clip.

Although the invention has been described with reference to specific embodiments, it will be understood by those skilled in the art that various changes can be made without departing from the spirit or scope of the invention. Accordingly, the disclosure of embodiments is intended to be illustrative of the scope of the invention and is not intended to be limiting. It is intended that the scope of the invention shall be limited only to the extent required by the appended claims. To one of ordinary skill in the art, it will be readily apparent that the semiconductor device and its methods of providing the semiconductor device discussed herein may be implemented in a variety of embodiments, and that the foregoing discussion of certain of these embodiments does not necessarily represent a complete description of all possible embodiments. Rather, the detailed description of the drawings, and the drawings themselves, disclose at least one preferred embodiment, and may disclose alternative embodiments.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A method of creating a clip, comprising:
generating one or more scene thumbnails corresponding to one or more scenes of a video;
displaying the one or more scene thumbnails;
receiving a user selection of one of the one or more scene thumbnails corresponding to the one or more scenes;
displaying the user selection of the one or more scenes using the one or more selected scene thumbnails in an edit mode;
receiving a user adjustment of the user selection; and
creating a clip based on the user adjustment of the user selection.

2. The method of claim 1, further comprising:
adding an image for a cover image.

3. The method of claim 1, further comprising:
adding a text caption.

4. The method of claim 1, further comprising:
adding a comment.

5. The method of claim 1, further comprising:
allowing the user to play a proposed clip based on the user adjustment of the user selection.

6. The method of claim 1, further comprising:
posting the clip one or more social networks.

7. The method of claim 1, wherein:
receiving the user adjustment comprises:
displaying a series of thumbnail images representing moments of the corresponding scene of the user selection;
displaying trimmer handles for the corresponding scene of the user selection;
allowing the user to alter the location of the trimmer handles; and
receiving the altered location of the trimmer handles.

8. The method of claim 7, wherein:
receiving the user adjustment further comprises:
allowing the user to zoom in on one or more thumbnail images in the series of thumbnails images.

9. The method of claim 8, wherein:
allowing the user to zoom in on more or more thumbnail images in the series of thumbnail images comprises displaying a series of secondary thumbnail images that represent wherein the series of secondary thumbnail images represents a segment from the selected scene.

10. The method of claim 1, wherein:
the one or more scenes comprise overlap between the one or more scenes.

11. The method of claim 9, wherein:
the overlap is ¼ of the length of each of the scenes.

12. The method of claim 1, further comprising:
displaying the clip on a frontend application.

13. A method for displaying an edit screen in an application, comprising:
receiving a selected scene from a user; and
arranging a display on a device to have a first trimmer handle, a second trimmer handle, a series of thumbnails, and a viewing window.

14. The method of claim 13, wherein:
the first trimmer handle is moveable by a user.

15. The method of claim 13, wherein:
the second trimmer handle is moveable by a user.

16. The method of claim 13, wherein:
each thumbnail from the series of thumbnails corresponds to an image from a scene in a video.

17. The method of claim 16, wherein:
the viewing window displays a portion of the video that is represented between the first trimmer handle and the second trimmer handle.

18. The method of claim 16, wherein:
arranging a display further comprises having an option to zoom in on any particular thumbnail in the series of thumbnails.

19. The method of claim 18, wherein:
the option to zoom comprises displaying a series of secondary thumbnails wherein the series of secondary thumbnail images represents a segment from the video.

20. A method of creating a clip, comprising:
receiving a user selection of a scene;
displaying the scene in an edit mode;
receiving a user adjustment of a start time and an end time;
receiving an alteration from a use; and
creating a clip based on the user adjustment and alteration;
wherein the alteration comprises:
at least one of the following:
a modification of the audio track;
a dubbed audio track;
addition of a second video;
addition of an image; or
addition of text.
